(19) United States
(12) Patent Application Publication
(10) Pub. No.: US 2025/0266854 A1
(43) Pub. Date: Aug. 21, 2025

(54) RADIO-FREQUENCY CIRCUIT

(71) Applicant: Murata Manufacturing Co., Ltd., Nagaokakyo-shi (JP)

(72) Inventor: Isao TAKENAKA, Nagaokakyo-shi (JP)

(73) Assignee: Murata Manufacturing Co., Ltd., Nagaokakyo-shi (JP)

(21) Appl. No.: 18/937,084

(22) Filed: Nov. 5, 2024

(30) Foreign Application Priority Data
Feb. 16, 2024 (JP) 2024-021858

(51) Int. Cl. H04B 1/04

(52) U.S. Cl. CPC H04B 1/0458; H04B 1/0483; H04B 2001/0416

(57) ABSTRACT

A radio-frequency circuit 1 includes a power amplifier configured to receive a first signal, a power amplifier configured to receive a second signal that is +90° relative to the first signal, a combiner circuit configured to combine in phase a third signal input from a fourth input port and a fourth signal input from a fifth input port, a phase shifter circuit coupled to a third output port of the power amplifier, a phase shifter circuit coupled to a fourth output port of the power amplifier, the forward phase of a fundamental wave in the phase shifter circuit being −90° relative to the phase shifter circuit, a harmonic phase shifter circuit coupled to the third output port, and a harmonic phase shifter circuit coupled to the fourth output port.

### CROSS-REFERENCE TO RELATED APPLICATION

This application claims priority to Japanese Patent Application No. JP 2024-021858 filed on Feb. 16, 2024. The entire contents of the above-identified application, including the specifications, drawings and claims, are incorporated herein by reference in their entirety.

### BACKGROUND OF THE DISCLOSURE

### 1. Field of the Disclosure

The present disclosure relates to radio-frequency circuits.

### 2. Description of the Related Art

Japanese Unexamined Patent Application Publication No. 2012-147352 discloses a semiconductor device (a radio-frequency circuit) including a first amplifier and a second amplifier that constitute a balanced amplifier, a first phase shifter circuit provided in a first output path that connects an output port of the first amplifier and an output terminal, a second phase shifter circuit provided in a second output path that connects an output port of the second amplifier and the output terminal, a resistor coupled to an output port of the first phase shifter circuit and an output port of a second phase shifter circuit, a first inductor coupled between the output port of the first phase shifter circuit and the output terminal, and a second inductor coupled between the output port of the second phase shifter circuit and the output terminal. It is explained that this configuration reduces power combining losses in a power coupler constituted by the resistor, the first inductor, and the second inductor.

### SUMMARY OF THE DISCLOSURE

With the demand for higher output power in mobile phones, there is a need for radio-frequency circuits that mitigate fluctuations in transmission characteristics caused by load variations.

The present disclosure has been made to solve the problem described above, and a feature thereof is to provide radio-frequency circuits that mitigate fluctuations in transmission characteristics caused by load variations.

To achieve the feature described above, a radio-frequency circuit according to an embodiment of the present disclosure includes a first antenna terminal, a splitter having a first input port, a first output port, and a second output port, the splitter being configured to split a fundamental signal of a transmit band of a first band that is input to the first input port, configured to output from the first output port a first split signal, and configured to output from the second output port a second split signal that has a phase of +90° relative to the first split signal, a first power amplifier having a second input port and a third output port, the second input port being coupled to the first output port, a second power amplifier having a third input port and a fourth output port, the third input port being coupled to the second output port, the power combiner circuit having the fourth input port, the fifth input port, and the fifth output port, configured to combine in phase the third split signal input from the fourth input port and the fourth split signal input from the fifth input port and output the generated output signal from the fifth output terminal, a first phase shifter circuit coupled between the third output port and the fourth input port, a second phase shifter circuit coupled between the fourth output port and the fifth input port, a first harmonic phase shifter circuit coupled between the third output port and the fourth input port and/or a second harmonic phase shifter circuit coupled between the fourth output port and the fifth input port, and a first filter coupled between the fifth output port and the first antenna terminal, the first filter having a pass band that includes the transmit band. The first phase shifter circuit and the second phase shifter circuit are configured such that a forward phase of a fundamental wave of the transmit band in the second phase shifter circuit in a direction from the fourth output port to the fifth input port is −90° relative to a forward phase of the fundamental wave in the first phase shifter circuit in a direction from the third output port to the fourth input port. The first phase shifter circuit, the second phase shifter circuit, the first harmonic phase shifter circuit, and the second harmonic phase shifter circuit are configured such that a difference between a first reflection phase of the fundamental wave assuming the fifth output port is observed from the third output port and a second reflection phase of the fundamental wave assuming the fifth output port is observed from the fourth output port is 180°, and a difference between a third reflection phase of at least one of harmonic waves of the transmit band assuming the fifth output port is observed from the third output port and a fourth reflection phase of the at least one of the harmonic waves assuming the fifth output port is observed from the fourth output port is 180°.

A radio-frequency circuit according to an embodiment of the present disclosure includes a first antenna terminal, a splitter having a first input port, a first output port, and a second output port, the splitter being configured to split a fundamental signal of a transmit band of a first band that is input to the first input port, configured to output from the first output port a first split signal, and configured to output from the second output port a second split signal that has a phase of +90° relative to the first split signal, a first power amplifier having a second input port and a third output port, the second input port being coupled to the first output port, a second power amplifier having a third input port and a fourth output port, the third input port being coupled to the second output port, the power combiner circuit having the fourth input port, the fifth input port, and the fifth output port, configured to combine in antiphase the third split signal input from the fourth input port and the fourth split signal input from the fifth input port and output the generated output signal from the fifth output terminal, a first phase shifter circuit coupled between the third output port and the fourth input port, a second phase shifter circuit coupled between the fourth output port and the fifth input port, a first harmonic phase shifter circuit coupled between the third output port and the fourth input port and/or a second harmonic phase shifter circuit coupled between the fourth output port and the fifth input port, and a first transmit filter coupled between the fifth output port and the first antenna terminal, the first transmit filter having a pass band that includes the transmit band. The first phase shifter circuit and the second phase shifter circuit are configured such that a forward phase of a fundamental wave of the transmit band in the second phase shifter circuit in a direction from the fourth output port to the fifth input port is −90° relative to a forward phase of the fundamental wave in the first phase shifter circuit in a direction from the third output port to the fourth input port. The first phase shifter circuit, the second phase shifter circuit, the first harmonic phase shifter circuit, and the second harmonic phase shifter circuit are configured such that a difference between a first reflection phase of the fundamental wave assuming the fifth output port is observed from the third output port and a second reflection phase of the fundamental wave assuming the fifth output port is observed from the fourth output port is 180°, and a difference between a third reflection phase of at least one of harmonic waves of the transmit band assuming the fifth output port is observed from the third output port and a fourth reflection phase of the at least one of the harmonic waves assuming the fifth output port is observed from the fourth output port is 180°.

The present disclosure provides radio-frequency circuits that mitigate fluctuations in transmission characteristics caused by load variations.

### BRIEF DESCRIPTION OF THE DRAWINGS

FIG. 1 is a circuit configuration diagram of an amplifier circuit, a radio-frequency circuit, and a communication device according to an embodiment;

FIG. 2A is a circuit state diagram of the radio-frequency circuit according to the embodiment in band-A transmission mode;

FIG. 2B is a circuit state diagram of the radio-frequency circuit according to the embodiment in band-B transmission mode;

FIG. 3A illustrates the fundamental impedances of power amplifiers according to the embodiment;

FIG. 3B illustrates the second harmonic impedances of the power amplifiers according to the embodiment;

FIG. 4A provides graphs illustrating the gain, error vector magnitude (EVIM), and adjacent channel leakage ratio (ACLR) of the amplifier circuit according to the embodiment;

FIG. 4B is a graph illustrating the output characteristics of the second harmonic wave of the amplifier circuit according to the embodiment;

FIG. 5A is a circuit configuration diagram of a first phase shifter circuit according to a first modification of the embodiment;

FIG. 5B is a circuit configuration diagram of a second phase shifter circuit according to the first modification of the embodiment;

FIG. 5C is a circuit configuration diagram of a first harmonic phase shifter circuit according to the first modification of the embodiment;

FIG. 5D is a circuit configuration diagram of a second harmonic phase shifter circuit according to the first modification of the embodiment;

FIG. 6 is a circuit configuration diagram of an amplifier circuit according to a second modification of the embodiment;

FIG. 7A illustrates the fundamental impedances of power amplifiers according to the second modification of the embodiment;

FIG. 7B illustrates the third harmonic impedances of the power amplifiers according to the second modification of the embodiment;

FIG. 8 is a graph illustrating the output characteristics of the third harmonic wave of the amplifier circuit according to the second modification of the embodiment;

FIG. 9 is a circuit configuration diagram of an amplifier circuit and a radio-frequency circuit according to a third modification of the embodiment;

FIG. 10 is a circuit configuration diagram of an amplifier circuit, a radio-frequency circuit, and a communication device according to a fourth modification of the embodiment; and

FIG. 11 provides plan views of the amplifier circuit according to the embodiment.

### DESCRIPTION OF THE PREFERRED EMBODIMENTS

Hereinafter, embodiments of the present disclosure will be described in detail with reference to the drawings. It may be noted that the embodiments described below provide comprehensive or specific examples. Details such as numerical values, shapes, materials, constituent elements, and arrangements and connection modes of the constituent elements provided in the following embodiments are illustrative and are not intended to limit the present disclosure.

The drawings are schematically illustrated with necessary emphasis, omissions, or proportion adjustments to depict the present disclosure and do not necessarily represent exact details; thus, the shapes, positional relationships, and proportions can differ from actual implementations. Identical reference numerals are assigned to substantially the same configuration elements across the drawings, and redundant descriptions of these configuration elements can be omitted or simplified.

In the drawings described later, the x-axis and the y-axis are perpendicular to each other in a plane parallel to the major surfaces of a mounting substrate. Specifically, assuming the mounting substrate is rectangular in plan view, the x-axis is parallel to a first side of the mounting substrate, and the y-axis is parallel to a second side perpendicular to the first side of the mounting substrate. The z-axis is perpendicular to the major surfaces of the mounting substrate. Along the z-axis, the positive direction indicates upward, and the negative direction indicates downward.

In the component arrangements of the present disclosure, the expression “a component is disposed at a substrate” includes the case in which the component is disposed at a major surface of the substrate and the case in which the component is disposed within the substrate. The expression “a component is disposed at a major surface of a substrate” applies assuming the component is disposed in contact with the major surface of the substrate and also assuming the component is disposed above the major surface without making contact with the major surface (for example, assuming the component is stacked on another component that is disposed in contact with the major surface). The expression “a component is disposed at a major surface of a substrate” may include the case in which the component is disposed in a depressed portion formed at the major surface. The expression “a component is disposed within a substrate” includes the case in which the component is encapsulated in the module substrate. The expression also includes the case in which the component is entirely positioned between the two major surfaces of the substrate but not fully covered by the substrate. The expression further includes the case in which only a portion of the component is disposed within the substrate.

In the component layouts of the present disclosure, the term “plan view of a major surface” refers to a situation in which an feature is orthogonally projected on an xy-plane and viewed from the positive side of the z-axis. The expression “A overlaps B in plan view” refers to a situation in which at least a portion of the region of A orthogonally projected on an xy plane coincides with at least a portion of the region of B orthogonally projected on the xy plane. The expression “A is disposed between B and C” refers to a situation in which at least one of the line segments each connecting any given point within B to any given point within C passes through A.

In the present disclosure, words used to express relationships between elements, such as parallel and vertical, words used to express the shape of an element, such as rectangular, and numerical ranges do not necessarily denote the exact meanings but denote substantially the same meanings involving, for example, several percent differences.

In the circuit configurations of the present disclosure, the term “couple” applies assuming one circuit element is directly coupled to another circuit element via a connection terminal and/or an interconnect conductor. The term also applies assuming one circuit element is electrically coupled to another circuit element via still another circuit element. The expression “coupled between A and B” means that a circuit element is coupled to both A and B while the circuit element is positioned between A and B.

In the present disclosure, the term “path” refers to a transmission line formed by, for example, a wire line for transferring radio-frequency signals, an electrode directly coupled to the wire line, and a terminal directly coupled to the wire line or electrode.

In the present disclosure, the expression “a component A is provided in series in a path B” means that both of the signal input port and the signal output port of the component A are coupled to a wire line, an electrode, or a terminal that constitute the path B.

As used in the present disclosure, the terms “terminal”, “input port”, and “output port” refer to a point at which a conductor within an element terminates. Assuming the impedance of a conductor between elements is sufficiently low, the “terminal” is interpreted not only as a single point but also as any point in the conductor between the elements, or as the entire conductor.

Terms describing relationships between elements, such as “parallel” and “vertical”, terms indicating an element's shape, such as “rectangular”, and numerical ranges are not meant to convey only precise meanings. These terms and numerical ranges denote meanings that are substantially the same, involving, for example, about several percent differences.

The term “pass band of a filter” refers to the portion of the frequency spectrum that can be transferred through the filter and is defined as the frequency range within which the output power is not attenuated by 3 dB or more below the maximum output power. Thus, the higher and lower limits of the pass band of a band pass filter are identified as the higher and lower frequencies of the two points at which the output power is attenuated by 3 dB below the maximum output power.

The term “transmit band” refers to a frequency band used for transmission in communication devices. The term “receive band” refers to a frequency band used for reception in communication devices. For example, in frequency division duplex (FDD), different frequency bands are used as the transmit band and the receive band; in time division duplex (TDD), the same frequency range is used as the transmit band and the receive band. In particular, assuming the communication devices are installed in user equipments (UEs) for cellular networks, uplink operation bands can be used as the transmit band, and downlink operation bands can be used as the receive band. Assuming the communication devices are installed as base stations (BSs) for cellular networks, downlink operation bands can be used as the transmit band, and uplink operation bands can be used as the receive band.

The “forward phase” of a radio-frequency signal between two ports can be determined by applying a measuring RF probe to the two ports and measuring the transfer characteristic (S21) using a network analyzer. The “reflection phase” of a radio-frequency signal at a port can be determined by applying a measuring RF probe to the port and measuring the transfer characteristic (S11) using a network analyzer.

### Embodiment

### 1 Circuit Configuration of Amplifier Circuit, Radio-Frequency Circuit, and Communication Device

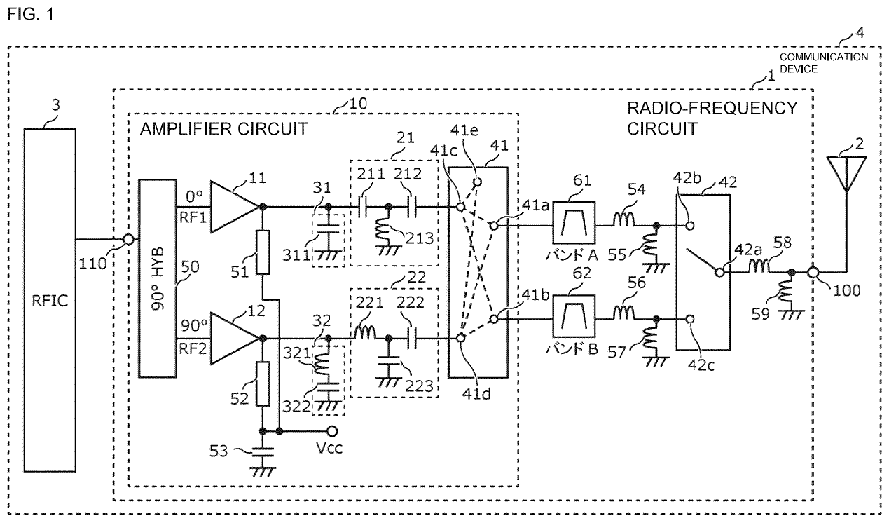

A circuit configuration of an amplifier circuit 10, a radio-frequency circuit 1, and a communication device 4 according to the present embodiment will be described with reference to FIG. 1. FIG. 1 is a circuit configuration diagram of the amplifier circuit 10, the radio-frequency circuit 1, and the communication device 4 according to an embodiment.

### 1.1 Circuit Configuration of Communication Device 4

First, a circuit configuration of the communication device 4 will be described. As illustrated in FIG. 1, the communication device 4 according to the present embodiment includes the radio-frequency circuit 1, an antenna 2, and a radio-frequency signal processing circuit (RFIC: radio frequency integrated circuit) 3.

The radio-frequency circuit 1 is operable to transfer radio-frequency signals between the antenna 2 and the RFIC 3. A detailed circuit configuration of the radio-frequency circuit 1 will be described later.

The antenna 2 is coupled to an antenna connection terminal 100 (a first antenna terminal) of the radio-frequency circuit 1. The antenna 2 is operable to transmit radio-frequency signals output from the radio-frequency circuit 1. The antenna 2 may be operable to receive radio-frequency signals from outside and output the radio-frequency signals to the radio-frequency circuit 1.

The RFIC 3 is an example of a signal processing circuit for processing radio-frequency signals.

Specifically, the RFIC 3 is operable to process, for example by up-conversion, a transmit signal inputted from a baseband signal processing circuit (BBIC; not illustrated in the drawing) and output the transmit signal generated by the signal processing to a transmit path in the radio-frequency circuit 1. The RFIC 3 is also operable to process, for example by down-conversion, a receive signal inputted through a receive path in the radio-frequency circuit 1 and output the receive signal generated by the signal processing to the BBIC. The RFIC 3 includes a control unit for controlling the radio-frequency circuit 1. The function of the control unit of the RFIC 3 may be partially or entirely implemented outside the RFIC 3; for example, the function of the control unit of the RFIC 3 may be partially or entirely implemented in the BBIC or the radio-frequency circuit 1.

The RFIC 3 also functions as a control unit for controlling a supply voltage Vcc and a bias current to be supplied to amplifiers included in the amplifier circuit 10. Specifically, the RFIC 3 outputs control signals to a power supply circuit (not illustrated in the drawing) and a bias circuit (not illustrated in the drawing). The power supply circuit and the bias circuit may be provided in the radio-frequency circuit 1 or the amplifier circuit 10. The power supply circuit is operable to supply to the amplifiers of the amplifier circuit 10 the supply voltage Vcc that is controlled based on the control signal. The bias circuit is operable to supply to the amplifiers of the amplifier circuit 10 the bias current that is controlled based on the control signal.

The RFIC 3 also functions as a control unit for controlling connections of switching circuits 41 and 42 included in the radio-frequency circuit 1, based on the frequency band in use.

In the communication device 4 according to the present embodiment, the antenna 2 is a non-essential constituent element.

### 1.2 Circuit Configuration of Radio-Frequency Circuit 1

Next, a circuit configuration of the radio-frequency circuit 1 will be described. As illustrated in FIG. 1, the radio-frequency circuit 1 includes the amplifier circuit 10, filters 61 and 62, the switching circuit 42, inductors 54 to 59, and the antenna connection terminal 100.

The amplifier circuit 10 is a circuit for amplifying transmit signals in bands A and B, inputted from a radio-frequency input terminal 110. Instead of the amplifier circuit 10, the radio-frequency circuit 1 may include a first amplifier circuit for amplifying transmit signals in the band A and a second amplifier circuit for amplifying transmit signals in the band B.

In the present embodiment, the bands A and B represent frequency bands determined by, for example, standards organizations such as the 3rd Generation Partnership Project (3GPP (registered trademark)) and the Institute of Electrical and Electronics Engineers (IEEE)) for communication systems built using a radio access technology (RAT). As the communication system in the present embodiment, for example, a 4th Generation Long Term Evolution (4G LTE) system, 5th Generation New Radio (5G NR) system, and Wireless Local Area Network (WLAN) system may be used, but these are not to be interpreted as limiting.

The filter 61 is an example of a first filter. The filter 61 is coupled between the switching circuit 41 and the antenna connection terminal 100. The filter 61 has a pass band that includes the transmit band of the band A (a first band). Specifically, one end of the filter 61 is coupled to a terminal 41a of the switching circuit 41, and the other end of the filter 61 is coupleable to the antenna connection terminal 100 via the inductors 54 and 58 and the switching circuit 42.

The filter 62 is an example of a second filter. The filter 62 is coupled between the switching circuit 41 and the antenna connection terminal 100. The filter 62 has a pass band that includes the transmit band of the band B (a second band). Specifically, one end of the filter 62 is coupled to a terminal 41b of the switching circuit 41, and the other end of the filter 62 is coupleable to the antenna connection terminal 100 via the inductors 56 and 58 and the switching circuit 42.

The switching circuit 42 is an example of an antenna switch. The switching circuit 42 has terminals 42a, 42b and 42c. The terminal 42a is coupled to the antenna connection terminal 100 via the inductor 58, the terminal 42b is coupled to the filter 61 via the inductor 54, and the terminal 42c is coupled to the filter 62 via the inductor 56. With the configuration described above, the switching circuit 42 is operable to alternate the connection and disconnection between the antenna connection terminal 100 and the filter 61 and also alternate the connection and disconnection between the antenna connection terminal 100 and the filter 62.

The inductor 54 is provided in series in the path connecting the terminal 42b of the switching circuit 42 and the filter 61. The inductor 55 is coupled between the path and ground. The inductors 54 and 55 are operable to provide impedance matching between the switching circuit 42 and the filter 61. The inductor 56 is provided in series in the path connecting the terminal 42c of the switching circuit 42 and the filter 62. The inductor 57 is coupled between the path and the ground. The inductors 56 and 57 are operable to provide impedance matching between the switching circuit 42 and the filter 62. The inductor 58 is provided in series in the path connecting the terminal 42a of the switching circuit 42 and the antenna connection terminal 100. The inductor 59 is coupled between the path and ground. The inductors 58 and 59 are operable to provide impedance matching between the switching circuit 42 and the antenna 2. It may be possible that at least one of the inductors 54 to 59 is not included.

The circuit configuration described above enables the radio-frequency circuit 1 to transmit radio-frequency signals in the bands A and B.

It is sufficient for the radio-frequency circuit 1 according to the present disclosure to include at least the amplifier circuit 10 and the filter 61 in the circuit configuration illustrated in FIG. 1.

### 1.3 Circuit Configuration of Amplifier Circuit 10

Next, a circuit configuration of the amplifier circuit 10 will be described in detail.

As illustrated in FIG. 1, the amplifier circuit 10 includes power amplifiers 11 and 12, phase shifter circuits 21 and 22, harmonic phase shifter circuits 31 and 32, the switching circuit 41, a 90° hybrid 50, phase shift lines 51 and 52, a capacitor 53, and the radio-frequency input terminal 110.

The radio-frequency input terminal 110 is coupled to the RFIC 3. Each of the radio-frequency input terminal 110 and the antenna connection terminal 100 may be a metal conductor such as a metal electrode or metal bump or may be a point (a node) in a metal wire line.

The 90° hybrid 50 is an example of a splitter. The 90° hybrid 50 has a first input port, a first output port, and a second output port. The first input port is coupled to the radio-frequency input terminal 110, the first output port is coupled to a second input port of the power amplifier 11, and the second output port is coupled to a third input port of the power amplifier 12. The 90° hybrid 50 is configured to split a fundamental signal in the transmit band of the band A or B that is input to the first input port, output a first split signal RF1 from the first output port, and output a second split signal RF2, which has a phase of +90° relative to the first split signal RF1, from the second output port.

The 90° hybrid 50 may be replaced with a phase shifter circuit configured in an alternative manner.

The power amplifier 11 is an example of a first power amplifier. The power amplifier 11 has the second input port and a third output port. The second input port is coupled to the first output port of the 90° hybrid 50. The power amplifier 12 is an example of a second power amplifier. The power amplifier 12 has the third input port and a fourth output port. The third input port is coupled to the second output port of the 90° hybrid 50. The power amplifiers 11 and 12 are able to amplify the radio-frequency signals in the band A or B that are output from the 90° hybrid 50.

Each of the power amplifiers 11 and 12 has an amplifier transistor. The amplifier transistor is, for example, a bipolar transistor, such as a heterojunction bipolar transistor (HBT), or a field-effect transistor, such as a metal-oxide-semiconductor field-effect transistor (MOSFET). Assuming the amplifier transistor is a bipolar transistor, the input port of each of the power amplifier 11 and 12 is, for example, the base terminal of the bipolar transistor, and the output port of each of the power amplifiers 11 and 12 is, for example, the collector terminal of the bipolar transistor. Assuming the amplifier transistor is a field-effect transistor, the input port of each of the power amplifiers 11 and 12 is, for example, the gate terminal of the field-effect transistor, and the output port of each of the power amplifiers 11 and 12 is, for example, the drain terminal of the field-effect transistor.

The phase shifter circuit 21 is an example of a first phase shifter circuit. The phase shifter circuit 21 is coupled between the third output port of the power amplifier 11 and a terminal 41c of the switching circuit 41. The phase shifter circuit 21 includes, for example, capacitors 211 and 212 and an inductor 213. The capacitor 211 is an example of a first capacitor. The capacitor 211 is coupled between the third output port and the terminal 41c. The inductor 213 is an example of a first inductor. The inductor 213 is coupled between ground and the path connecting the capacitor 211 and the terminal 41c. The capacitor 212 is provided in series in the path connecting the capacitor 211 and the terminal 41c. The phase shifter circuit 21 is configured as a high pass filter. The phase shifter circuit 21 is operable to introduce, for example, a phase shift of +45° (a phase advance of 45°) to the forward phase of the fundamental waves in the bands A and B. The capacitor 212 is a direct-current (DC) blocking capacitor and does not contribute to phase shift. The capacitor 212 is not necessarily included in the phase shifter circuit 21.

The phase shifter circuit 22 is an example of a second phase shifter circuit. The phase shifter circuit 22 is coupled between the fourth output port of the power amplifier 12 and a terminal 41d of the switching circuit 41. The phase shifter circuit 22 is configured such that the forward phase of the fundamental waves in the bands A and B in the direction from the fourth output port to the terminal 41d is −90° (a phase delay of 90°) relative to the forward phase of the fundamental waves in the bands A and B in the phase shifter circuit 21 in the direction from the third output port to the terminal 41c. The phase shifter circuit 22 includes, for example, an inductor 221 and capacitors 222 and 223. The inductor 221 is an example of a second inductor. The inductor 221 is coupled between the fourth output port and the terminal 41d. The capacitor 223 is an example of a second capacitor. The capacitor 223 is coupled between ground and the path connecting the inductor 221 and the terminal 41d. The capacitor 222 is provided in series in the path connecting the inductor 221 and the terminal 41d. The phase shifter circuit 22 is configured as a low pass filter. The phase shifter circuit 22 is operable to introduce, for example, a phase shift of −45° (a phase delay of 45°) to the forward phase of the fundamental signals in the bands A and B. The capacitor 222 is a DC blocking capacitor and does not contribute to phase shift. The capacitor 222 is not necessarily included in the phase shifter circuit 22.

The harmonic phase shifter circuit 31 is an example of a first harmonic phase shifter circuit. The harmonic phase shifter circuit 31 is coupled between the third output port of the power amplifier 11 and the terminal 41c of the switching circuit 41. The harmonic phase shifter circuit 31 includes, for example, a capacitor 311 (a third capacitor) coupled between ground and the path connecting the third output port and the capacitor 211. The harmonic phase shifter circuit 31 operates as a low pass filter with a pass band that corresponds to the fundamental frequency ranges of the bands A and B. The forward phase of the fundamental waves is, for example, 0°.

The harmonic phase shifter circuit 32 is an example of a second harmonic phase shifter circuit. The harmonic phase shifter circuit 32 is coupled between the fourth output port of the power amplifier 12 and the terminal 41d of the switching circuit 41. The harmonic phase shifter circuit 32 includes, for example, an inductor 321 and a capacitor 322. The inductor 321 (a third inductor) and the capacitor 322 (a fourth capacitor) form an LC circuit by being coupled in series with each other. The LC circuit is coupled between ground and the path connecting the fourth output port and the inductor 221. The harmonic phase shifter circuit 32 operates as a notch filter with a pass band that corresponds to the fundamental frequency ranges of the bands A and B. The forward phase of the fundamental waves is, for example, 0°.

The phase shifter circuit 21 and the harmonic phase shifter circuit 31 are configured such that the forward phase of the second harmonic waves in the bands A and B in the circuit formed by combining the phase shifter circuit 21 and the harmonic phase shifter circuit 31 is +45° (a phase advance of 45°). The phase shifter circuit 22 and the harmonic phase shifter circuit 32 are configured such that the forward phase of the second harmonic waves in the circuit formed by combining the phase shifter circuit 22 and the harmonic phase shifter circuit 32 is −45° (a phase delay of 45°).

The switching circuit 41 is an example of a combiner circuit. The switching circuit 41 has the terminal 41a (a fifth output port), the terminal 41b (a sixth output port), the terminal 41c (a fourth input port), the terminal 41d (a fifth input port), and a terminal 41e (a monitoring terminal). The switching circuit 41 is operable to alternate between connecting the terminals 41c and 41a as well as connecting the terminals 41d and 41a and connecting the terminals 41c and 41b as well as connecting the terminals 41d and 41b. With this configuration, the switching circuit 41 outputs from the terminal 41a the output signal generated by combining in phase at the terminal 41a a third split signal in the band A input from the terminal 41c and a fourth split signal in the band A input from the terminal 41d. The switching circuit 41 outputs from the terminal 41b the output signal generated by combining in phase at the terminal 41b a third split signal in the band B input from the terminal 41c and a fourth split signal in the band B input from the terminal 41d. The terminal 41a serves as the signal combining point for combining in phase the band-A third split signal and the band-A fourth split signal. The terminal 41b is the signal combining point for combining in phase the band-B third split signal and the band-B fourth split signal.

The terminal 41e (a monitoring terminal) is used, for example, to measure the reflection phase assuming observing the switching circuit 41 side from the collector terminal (a third output port) of the power amplifier 11 or the collector terminal (a third output port) of the power amplifier 12. Specifically, in the state in which the terminal 41e is connected to the terminal 41c while the terminal 41c is disconnected from the terminals 41a and 41b, the reflection phases of the fundamental wave and the second harmonic wave of the band A or B can be measured at the terminal 41e. The reflection phases measured in the state in which the terminal 41e is coupled to the terminal 41c is equivalent to the reflection phases of the fundamental wave and the second harmonic wave of the band A or B measured from the collector terminal of the power amplifier 11. In the state in which the terminal 41e is connected to the terminal 41d while the terminal 41d is disconnected from the terminals 41a and 41b, the reflection phases of the fundamental wave and the second harmonic wave of the band A or B can be measured at the terminal 41e. The reflection phases measured in the state in which the terminal 41e is coupled to the terminal 41d is equivalent to the reflection phases of the fundamental wave and the second harmonic wave of the band A or B measured from the collector terminal of the power amplifier 12.

The phase shift line 51 is provided in series between the third output port of the power amplifier 11 and a supply voltage (Vcc) terminal. The phase shift line 51 is operable to suppress leakage of a first radio-frequency signal, output from the power amplifier 11, to the Vcc terminal. The phase shift line 52 is provided in series between the fourth output port of the power amplifier 12 and the supply voltage (Vcc) terminal. The phase shift line 52 is operable to suppress leakage of a second radio-frequency signal, output from the power amplifier 12, to the Vcc terminal. The capacitor 53 is coupled between the Vcc terminal and the ground. The capacitor 53 is operable to inhibit leakage components of the first radio-frequency signal and the second radio-frequency signal from leaking into the Vcc terminal and also inhibit the supply voltage from flowing to ground.

In the amplifier circuit 10 configured as described above, the phase shifter circuits 21 and 22 and the harmonic phase shifter circuits 31 and 32 are configured such that: the difference between a first reflection phase of the fundamental wave of the band-A transmit band assuming the terminal 41a is observed from the third output port and a second reflection phase of the fundamental wave of the band-A transmit band assuming the terminal 41a is observed from the fourth output port is 180°; and the difference between a third reflection phase of the second harmonic wave of the band-A transmit band assuming the terminal 41a is observed from the third output port and a fourth reflection phase of the second harmonic wave of the band-A transmit band assuming the terminal 41a is observed from the fourth output port is 180°.

The first reflection phase of the fundamental wave of the band-A transmit band assuming the terminal 41a is observed from the third output port is defined as the phase shift of the fundamental wave of the reflected signal reflected at the terminal 41a and returned to the third output port, relative to the phase of the fundamental wave of the transmit signal in the band-A transmit band that is output from the third output port, in the state in which the terminal 41c is connected to the terminal 41a while the terminal 41a is disconnected from the filter 61. The second reflection phase of the fundamental wave of the band-A transmit band assuming the terminal 41a is observed from the fourth output port is defined as the phase shift of the fundamental wave of the reflected signal reflected at the terminal 41a and returned to the fourth output port, relative to the phase of the fundamental wave of the transmit signal in the band-A transmit band that is output from the fourth output port, in the state in which the terminal 41d is connected to the terminal 41a while the terminal 41a is disconnected from the filter 61. The third reflection phase of the second harmonic wave of the band-A transmit band assuming the terminal 41a is observed from the third output port is defined as the phase shift of the second harmonic wave of the reflected signal reflected at the terminal 41a and returned to the third output port, relative to the phase of the second harmonic wave of the transmit signal in the band-A transmit band that is output from the third output port, in the state in which the terminal 41c is connected to the terminal 41a while the terminal 41a is disconnected from the filter 61. The fourth reflection phase of the second harmonic wave of the band-A transmit band assuming the terminal 41a is observed from the fourth output port is defined as the phase shift of the second harmonic wave of the reflected signal reflected at the terminal 41a and returned to the fourth output port, relative to the phase of the second harmonic wave of the transmit signal in the band-A transmit band that is output from the fourth output port, in the state in which the terminal 41d is connected to the terminal 41a while the terminal 41a is disconnected from the filter 61.

The first reflection phase of the fundamental wave of the band-A transmit band can be obtained by measuring the reflection phase of the fundamental wave of the band A at the terminal 41a in the state in which the terminal 41c is connected to the terminal 41a, the terminal 41d is disconnected from the terminal 41a, and the terminal 41a is disconnected from the filter 61. The first reflection phase of the fundamental wave of the band-B transmit band can be obtained by measuring the reflection phase of the fundamental wave of the band B at the terminal 41b in the state in which the terminal 41c is connected to the terminal 41b, the terminal 41d is disconnected from the terminal 41b, and the terminal 41b is disconnected from the filter 62.

The second reflection phase of the fundamental wave of the band-A transmit band can be obtained by measuring the reflection phase of the fundamental wave of the band A at the terminal 41a in the state in which the terminal 41d is connected to the terminal 41a, the terminal 41c is disconnected from the terminal 41a, and the terminal 41a is disconnected from the filter 61. The second reflection phase of the fundamental wave of the band-B transmit band can be obtained by measuring the reflection phase of the fundamental wave of the band B at the terminal 41b in the state in which the terminal 41d is connected to the terminal 41b, the terminal 41c is disconnected from the terminal 41b, and the terminal 41b is disconnected from the filter 62.

The third reflection phase of the second harmonic wave of the band-A transmit band can be obtained by measuring the reflection phase of the second harmonic wave of the band A at the terminal 41a in the state in which the terminal 41c is connected to the terminal 41a, the terminal 41d is disconnected from the terminal 41a, and the terminal 41a is disconnected from the filter 61. The third reflection phase of the second harmonic wave of the band-B transmit band can be obtained by measuring the reflection phase of the second harmonic wave of the band B at the terminal 41b in the state in which the terminal 41c is connected to the terminal 41b, the terminal 41d is disconnected from the terminal 41b, and the terminal 41b is disconnected from the filter 62.

The fourth reflection phase of the second harmonic wave of the band-A transmit band can be obtained by measuring the reflection phase of the second harmonic wave of the band A at the terminal 41a in the state in which the terminal 41d is connected to the terminal 41a, the terminal 41c is disconnected from the terminal 41a, and the terminal 41a is disconnected from the filter 61. The fourth reflection phase of the second harmonic wave of the band-B transmit band can be obtained by measuring the reflection phase of the second harmonic wave of the band B at the terminal 41b in the state in which the terminal 41d is connected to the terminal 41b, the terminal 41c is disconnected from the terminal 41b, and the terminal 41b is disconnected from the filter 62.

With the configuration described above, assuming unwanted signals at the fundamental and second harmonic frequencies of the band-A transmit band leak into the radio-frequency circuit 1 through the antenna connection terminal 100 from external circuits, the reflection phase difference between the fundamental waves observed from the output ports of the two balanced power amplifiers 11 and 12 is 180°, and the reflection phase difference of the second harmonic waves is also 180°. As a result, fluctuations in the transmission characteristics of the radio-frequency circuit 1 in the fundamental and harmonic frequency ranges can be suppressed regardless of load variations. As such, the amplifier circuit 10 and the radio-frequency circuit 1 is provided in the manner that mitigates fluctuations in the output characteristics of the fundamental and harmonic frequency ranges of transmit signals.

In the amplifier circuit 10 and the radio-frequency circuit 1 according to the present embodiment, the phase shifter circuits 21 and 22 and the harmonic phase shifter circuits 31 and 32 control the phase of the fundamental wave and the phase of the second harmonic wave. However, the phase shifter circuits 21 and 22 and the harmonic phase shifter circuits 31 and 32 may control the phase of the fundamental wave and the phase of at least one of the nth harmonic waves (n is an integer greater than or equal to 3).

This means that assuming unwanted signals at the fundamental and nth (n is an integer greater than or equal to 3) harmonic frequencies of the band-A transmit band leak into the radio-frequency circuit through the antenna connection terminal 100 from external circuits, it is sufficient that the reflection phase difference between the fundamental waves observed from the output ports of the two balanced power amplifiers 11 and 12 is 180°, and the reflection phase difference of the nth harmonic waves is also 180°. With this configuration, fluctuations in the transmission characteristics of the fundamental and nth harmonic frequency ranges of the radio-frequency circuit can be suppressed regardless of load variations. As such, an amplifier circuit and a radio-frequency circuit are provided in the manner that mitigates fluctuations in the output characteristics of the fundamental and nth harmonic frequency ranges of transmit signals.

### 1.4 Transmission Characteristics of Radio-Frequency Circuit 1

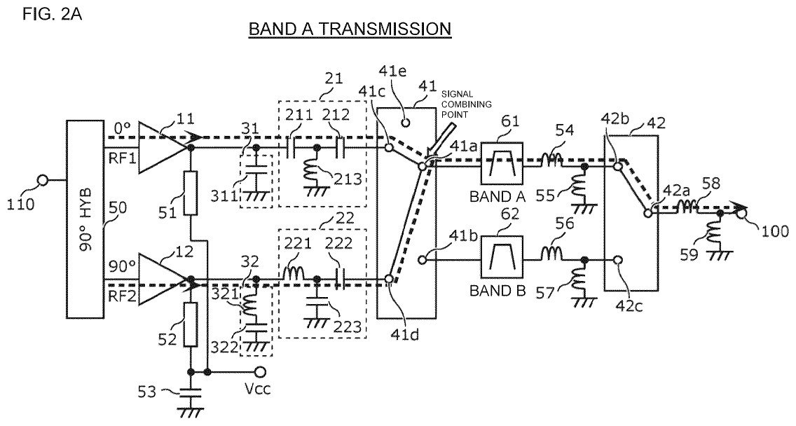

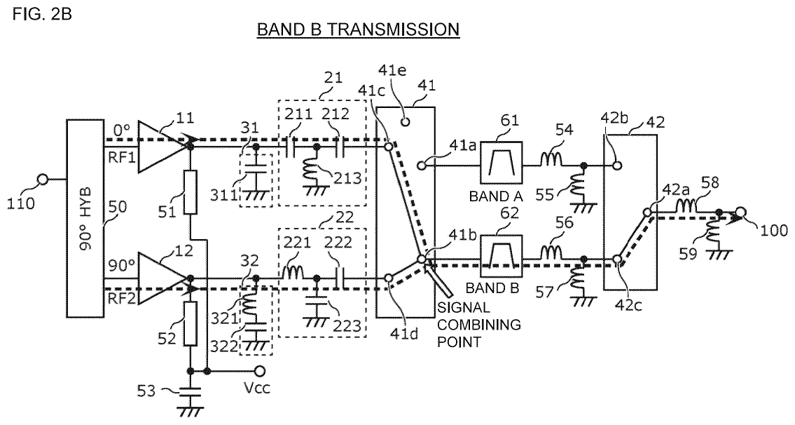

FIG. 2A is a circuit state diagram of the radio-frequency circuit 1 according to the embodiment in band-A transmission mode. As illustrated in the drawing, in band-A transmission mode, the terminals 41a and 41c are connected and the terminals 41a and 41d are connected in the switching circuit 41. The terminals 42a and 42b are connected in the switching circuit 42.

A band-A transmit signal is split by the 90° hybrid 50 into the first split signal RF1 and the second split signal RF2. The first split signal RF1 and the second split signal RF2 are respectively input to the power amplifiers 11 and 12 and amplified into a first signal and a second signal. At the third output port of the power amplifier 11, the phase of the fundamental wave of the first signal is 0°. At the fourth output port of the power amplifier 12, the phase of the fundamental wave of the second signal is 90°.

After the first signal passes through the harmonic phase shifter circuit 31 (with a fundamental-wave forward phase of 0°) and the phase shifter circuit 21 (with a fundamental-wave forward phase of +45°), the phase of the fundamental wave of the first signal is +45° at the terminal 41a. After the second signal passes through the harmonic phase shifter circuit 32 (with a fundamental-wave forward phase of 0°) and the phase shifter circuit 22 (with a fundamental-wave forward phase of −45°), the phase of the fundamental wave of the second signal is +45° at the terminal 41a. As a result, the band-A first signal and the band-A second signal can be combined in phase at the terminal 41a. This configuration enables highly efficient power combining of the fundamental wave with respect to load variations.

The difference between the first reflection phase (+45°×2=90°) of the fundamental wave of the first signal assuming the terminal 41a is observed from the third output port and the second reflection phase (−45°×2=−90°) of the fundamental wave of the second signal assuming the terminal 41a is observed from the fourth output port is 1800.

The forward phase of the second harmonic wave of the first signal in the circuit formed by combining the harmonic phase shifter circuit 31 and the phase shifter circuit 21 is +45°. The forward phase of the second harmonic wave of the second signal in the circuit formed by combining the harmonic phase shifter circuit 32 and the phase shifter circuit 22 is −45°. In other words, the difference between the third reflection phase (+45°×2=90°) of the second harmonic wave of the first signal assuming the terminal 41a is observed from the third output port and the fourth reflection phase (−45°×2=−90°) of the second harmonic wave of the second signal assuming the terminal 41a is observed from the fourth output port is 1800.

FIG. 2B is a circuit state diagram of the radio-frequency circuit 1 according to the embodiment in band-B transmission mode. As illustrated in the drawing, in band-B transmission mode, the terminals 41b and 41c are connected and the terminals 41b and 41d are connected in the switching circuit 41. The terminals 42a and 42c are connected in the switching circuit 42.

A band-B transmit signal is split by the 90° hybrid 50 into the first split signal RF1 and the second split signal RF2. The first split signal RF1 and the second split signal RF2 are respectively input to the power amplifiers 11 and 12 and amplified into a first signal and a second signal. At the third output port of the power amplifier 11, the phase of the fundamental wave of the first signal is 0°. At the fourth output port of the power amplifier 12, the phase of the fundamental wave of the second signal is 90°.

After the first signal passes through the harmonic phase shifter circuit 31 (with a fundamental-wave forward phase of 0°) and the phase shifter circuit 21 (with a fundamental-wave forward phase of +45°), the phase of the fundamental wave of the first signal is +45° at the terminal 41b. After the second signal passes through the harmonic phase shifter circuit 32 (with a fundamental-wave forward phase of 0°) and the phase shifter circuit 22 (with a fundamental-wave forward phase of −45°), the phase of the fundamental wave of the second signal is +45° at the terminal 41b. As a result, the band-B first signal and the band-A second signal can be combined in phase at the terminal 41b. This configuration enables highly efficient power combining of the fundamental wave with respect to load variations.

The difference between the first reflection phase (+45°×2=90°) of the fundamental wave of the first signal assuming the terminal 41b is observed from the third output port and the second reflection phase (−45°×2=−90°) of the fundamental wave of the second signal assuming the terminal 41b is observed from the fourth output port is 1800.

The forward phase of the second harmonic wave of the first signal in the circuit formed by combining the harmonic phase shifter circuit 31 and the phase shifter circuit 21 is +45°. The forward phase of the second harmonic wave of the second signal in the circuit formed by combining the harmonic phase shifter circuit 32 and the phase shifter circuit 22 is −45°. In other words, the difference between the third reflection phase (+45°×2=90°) of the second harmonic wave of the first signal assuming the terminal 41b is observed from the third output port and the fourth reflection phase (−45°×2=−90°) of the second harmonic wave of the second signal assuming the terminal 41b is observed from the fourth output port is 1800.

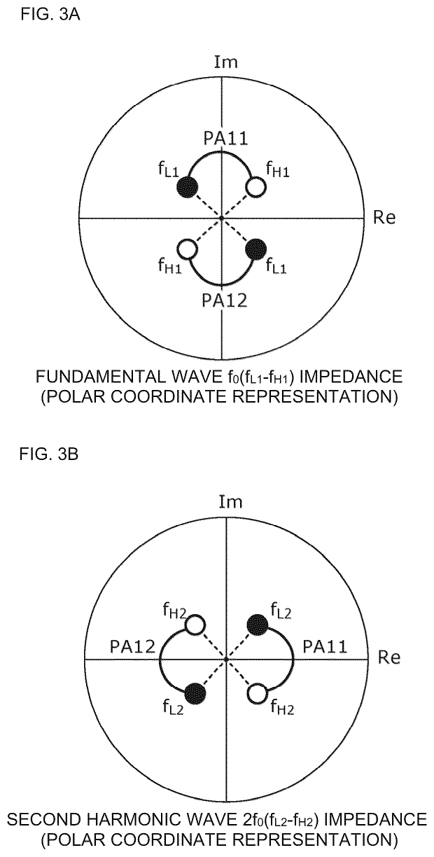

FIG. 3A illustrates the fundamental impedances of the power amplifiers 11 and 12 according to the embodiment. FIG. 3B illustrates the second harmonic impedances of the power amplifiers 11 and 12 according to the embodiment. FIG. 3A illustrates the impedance of the band-A fundamental wave (frequencies f_{L1} to f_{H1}) at the third output port of the power amplifier 11 (PA11) and the impedance of the band-A fundamental wave at the fourth output port of the power amplifier 12 (PA12) in polar coordinates. FIG. 3B illustrates the impedance of the band-A second harmonic wave (frequencies f_{L2} to f_{H2}) at the third output port of the power amplifier 11 (PA11) and the impedance of the band-A second harmonic wave at the fourth output port of the power amplifier 12 (PA12) in polar coordinates.

As illustrated in FIG. 3A, the difference between the first reflection phase of the fundamental wave and the second reflection phase of the fundamental wave is 180°. As a result, a consistent phase difference of 180° is maintained between the fundamental impedance of the power amplifier 11 and the fundamental impedance of the power amplifier 12 across the band-A fundamental frequency range (frequencies f_{L1} to f_{H1}). Thus, the radio-frequency circuit 1 cancels out load variations in the band-A fundamental frequency range and achieves stable transmission output characteristics across the fundamental frequency range.

As illustrated in FIG. 3B, the difference between the third reflection phase of the second harmonic wave and the fourth reflection phase of the second harmonic wave is 180°. As a result, a consistent phase difference of 180° is maintained between the second harmonic impedance of the power amplifier 11 and the second harmonic impedance of the power amplifier 12 across the band-A second harmonic frequency range (frequencies f_{L2} to f_{H2}). Thus, the radio-frequency circuit 1 cancels out load variations in the band-A second harmonic frequency range and achieves stable transmission output characteristics across the second harmonic frequency range.

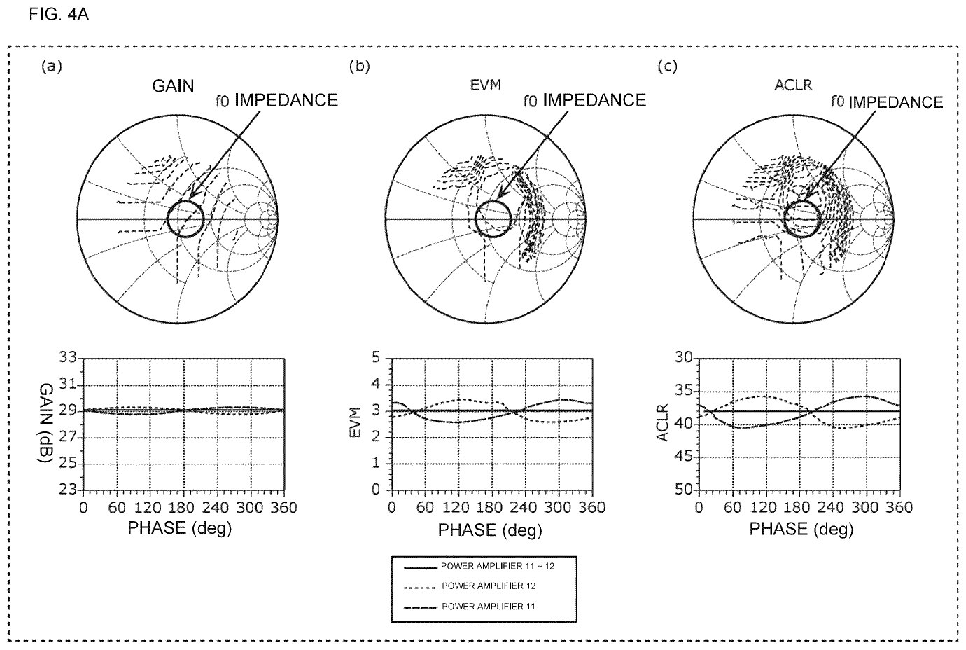

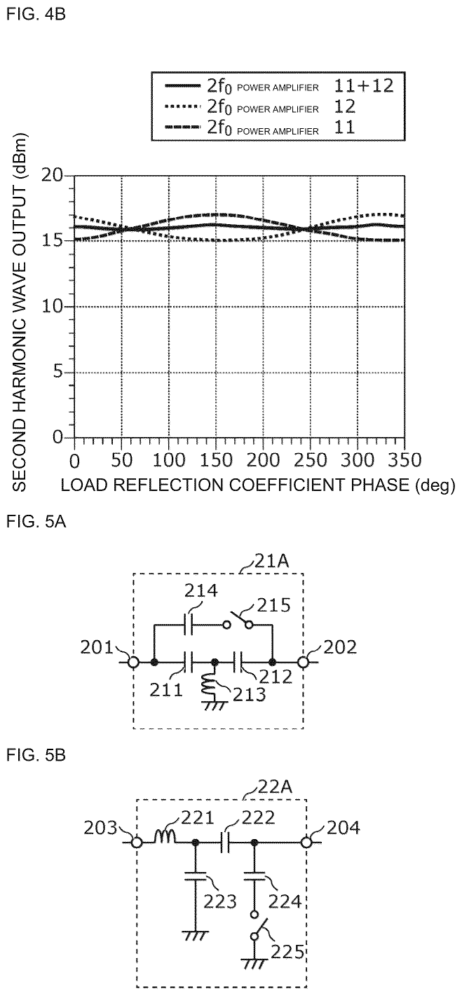

FIG. 4A provides graphs illustrating the gain, error vector magnitude (EVIM), and adjacent channel leakage ratio (ACLR) of the amplifier circuit 10 according to the embodiment. FIG. 4B is a graph illustrating the output characteristics of the second harmonic wave of the amplifier circuit 10 according to the embodiment. The upper portion of FIG. 4A illustrates the fundamental impedance with a load impedance of F=0.2 on Smith charts with contour plots of (a) gain, (b) EVM, and (c) ACLR from load-pull measurements. The lower portion of FIG. 4A illustrates the results of mapping the contour plots on the fundamental impedance.

As illustrated in FIG. 4A, the gain, EVM, and ACLR of each of the power amplifiers 11 and 12, fluctuate with load variations (phase variations). However, because the difference between the first reflection phase of the fundamental wave and the second reflection phase of the fundamental wave is 180°, variations in the gain, EVM, and ACLR of the combined fundamental wave from the power amplifiers 11 and 12 are suppressed. As a result, the amplifier circuit 10 achieves stable transmission output characteristics of the fundamental wave, regardless of the presence of load variations.

As illustrated in FIG. 4B, the second harmonic outputs of the power amplifiers 11 and 12 fluctuate with load variations (phase variations). However, because the difference between the third reflection phase of the second harmonic wave and the fourth reflection phase of the second harmonic wave is 180°, variations in the combined second harmonic output formed by combining the second harmonic waves from the power amplifiers 11 and 12 are suppressed. As a result, the amplifier circuit 10 achieves stable transmission output characteristics of the second harmonic wave, regardless of the presence of load variations.

Known amplifier circuits with balanced first and second power amplifiers have a 90° fundamental phase difference at the output ports of the first and second power amplifiers, perform in-phase combining at the combining point, and suppress harmonic waves.

However, under the circumstance where high output power performance is desired, an issue arises: the need to operate with both the fundamental wave and the harmonic wave while stably outputting the fundamental wave and the harmonic wave regardless of load variations. To address the issue, it is highly effective and significant to maintain a reflection phase difference of 180° at the output ports of the power amplifiers 11 and 12 in the two frequency ranges of the fundamental wave and the harmonic wave, as in the amplifier circuit 10 and the radio-frequency circuit 1 according to the present embodiment.

It may be noted that in the amplifier circuit 10 according to the present embodiment, either the harmonic phase shifter circuit 31 or 32 may be excluded. It is sufficient for the amplifier circuit according to the present disclosure to have a circuit configuration that achieves a 180° phase difference between the reflection phase of the second harmonic wave of the first signal in the path connecting the third output port of the power amplifier 11 and the terminal 41a (combining point) and the reflection phase of the second harmonic wave of the second signal in the path connecting the fourth output port of the power amplifier 12 and the terminal 41a.

In the present embodiment, the numerical values for forward phase, reflection phase, and reflection phase difference do not necessarily represent exact values but represent substantially the same values involving, for example, about 30% differences.

### 2 Circuit Configuration of Amplifier Circuit According to First Modification

An amplifier circuit according to a first modification will be described. The amplifier circuit according to the present modification includes power amplifiers 11 and 12, phase shifter circuits 21A and 22A, harmonic phase shifter circuits 31A and 32A, a switching circuit 41, a 90° hybrid 50, phase shift lines 51 and 52, a capacitor 53, and a radio-frequency input terminal 110. The amplifier circuit according to the present modification differs from the amplifier circuit 10 according to the embodiment in the circuit configuration of the phase shifter circuit and the harmonic phase shifter circuit. The following describes the amplifier circuit according to the present modification, focusing on the phase shifter circuits 21A and 22A and the harmonic phase shifter circuits 31A and 32A, which are different configurational features from the amplifier circuit 10 according to the embodiment, and descriptions of the same configurational features as the amplifier circuit 10 according to the embodiment will not be repeated.

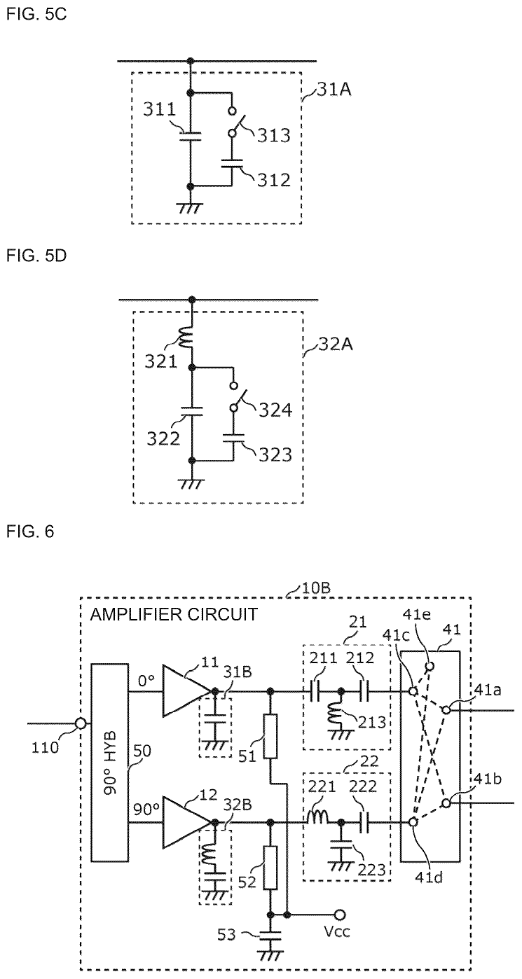

FIG. 5A is a circuit configuration diagram of the phase shifter circuit 21A according to the first modification of the embodiment. The phase shifter circuit 21A is an example of a first phase shifter circuit. The phase shifter circuit 21A is coupled between a third output port of the power amplifier 11 and a terminal 41c of the switching circuit 41. The phase shifter circuit 21A includes capacitors 211, 212, and 214, an inductor 213, and a switch 215. The capacitor 211 is an example of a first capacitor. The capacitor 211 is coupled between terminals 201 and 202. The inductor 213 is an example of a first inductor. The inductor 213 is coupled between ground and the path connecting the capacitor 211 and the terminal 202. The capacitor 212 is provided in series in the path connecting the capacitor 211 and the terminal 202. The switch 215 (a fifth switch) and the capacitor 214 are coupled in series with each other to form a first variable circuit. The first variable circuit is coupled between the terminals 201 and 202. The phase shifter circuit 21A is configured as a high pass filter. The phase shifter circuit 21A is operable to introduce, for example, a phase shift of +450 (a phase advance of 45°) to the forward phase of the fundamental waves in the bands A and B. The capacitor 212 is a DC blocking capacitor and does not contribute to phase shift. The capacitor 212 is not necessarily included in the phase shifter circuit 21A. The forward phase of the fundamental wave can be changed by switching between the closed state and the open state of the switch 215. For example, the switch 215 can be closed or open depending on whether the amplifier circuit according to the present modification transfers band-A or band-B transmit signals. In other words, the phase shifter circuit 21A is configured such that the forward phase can be changed by alternating between connecting the terminals 41c and 41d to the terminal 41a and connecting the terminals 41c and 41d to the terminal 41b. This configuration highly precisely controls the reflection phase shift of the fundamental wave to match the band being transferred.

FIG. 5B is a circuit configuration diagram of the phase shifter circuit 22A according to the first modification of the embodiment. The phase shifter circuit 22A is an example of a second phase shifter circuit. The phase shifter circuit 22A is coupled between terminals 203 and 204. The phase shifter circuit 22A is configured such that the forward phase of the fundamental waves in the bands A and B is −90° (a phase delay of 90°) relative to the phase shifter circuit 21A. The phase shifter circuit 22A includes an inductor 221, capacitors 222, 223, and 224, and a switch 225. The inductor 221 is an example of a second inductor. The inductor 221 is coupled between the terminals 203 and 204. The capacitor 223 is an example of a second capacitor. The capacitor 223 is coupled between ground and the path connecting the inductor 221 and the terminal 204. The capacitor 222 is provided in series in the path connecting the inductor 221 and the terminal 204. The switch 225 (a sixth switch) and the capacitor 224 are coupled in series with each other to form a second variable circuit. The second variable circuit is coupled between the terminal 204 and ground. The phase shifter circuit 22A is configured as a low pass filter. The phase shifter circuit 22A is operable to introduce, for example, a phase shift of −45° (a phase delay of 45°) to the forward phase of the fundamental signals in the bands A and B. The capacitor 222 is a DC blocking capacitor and does not contribute to phase shift. The capacitor 222 is not necessarily included in the phase shifter circuit 22A. The forward phase of the fundamental wave can be changed by switching between the closed state and the open state of the switch 225. For example, the switch 215 can be closed or open depending on whether the amplifier circuit according to the present modification transfers band-A or band-B transmit signals. In other words, the phase shifter circuit 22A is configured such that the forward phase can be changed by alternating between connecting the terminals 41c and 41d to the terminal 41a and connecting the terminals 41c and 41d to the terminal 41b. This configuration highly precisely controls the reflection phase shift of the fundamental wave to match the band being transferred.

FIG. 5C is a circuit configuration diagram of the harmonic phase shifter circuit 31A according to the first modification of the embodiment. The harmonic phase shifter circuit 31A is an example of a first harmonic phase shifter circuit. The harmonic phase shifter circuit 31A is coupled between the third output port and the terminal 41c. The harmonic phase shifter circuit 31A includes capacitors 311 and 312 and a switch 313. The capacitor 311 is coupled between ground and the path connecting the third output port and the capacitor 211. The switch 313 (a seventh switch) and the capacitor 312 are coupled in series with each other to form a third variable circuit. The third variable circuit is coupled between the path described above and ground. The harmonic phase shifter circuit 31A operates as a low pass filter with a pass band that corresponds to the fundamental frequency ranges of the bands A and B. The forward phase of the fundamental waves is, for example, 0°. The forward phase of the second harmonic wave can be changed by switching between the closed state and the open state of the switch 313. For example, the switch 313 can be closed or open depending on whether the amplifier circuit according to the present modification transfers band-A or band-B transmit signals. In other words, the harmonic phase shifter circuit 31A is configured such that the forward phase can be changed by alternating between connecting the terminals 41c and 41d to the terminal 41a and connecting the terminals 41c and 41d to the terminal 41b. This configuration highly precisely controls the reflection phase shift of the second harmonic wave to match the band being transferred.

FIG. 5D is a circuit configuration diagram of the harmonic phase shifter circuit 32A according to the first modification of the embodiment. The harmonic phase shifter circuit 32A is an example of a second harmonic phase shifter circuit. The harmonic phase shifter circuit 32A is coupled between the fourth output port and the terminal 41d. The harmonic phase shifter circuit 32A includes an inductor 321, capacitors 322 and 323, and a switch 324. The inductor 321 and the capacitor 322 form an LC circuit by being coupled in series with each other. The LC circuit is coupled between ground and the path connecting the fourth output port and the inductor 221. The switch 324 (an eighth switch) and the capacitor 323 are coupled in series with each other to form a fourth variable circuit. The fourth variable circuit is coupled in parallel with the capacitor 322. The harmonic phase shifter circuit 32A operates as a notch filter with a pass band that corresponds to the fundamental frequency ranges of the bands A and B. The forward phase of the fundamental waves is, for example, 0°. The forward phase of the second harmonic wave can be changed by switching between the closed state and the open state of the switch 324. For example, the switch 324 can be closed or open depending on whether the amplifier circuit according to the present modification transfers band-A or band-B transmit signals. In other words, the harmonic phase shifter circuit 32A is configured such that the forward phase can be changed by alternating between connecting the terminals 41c and 41d to the terminal 41a and connecting the terminals 41c and 41d to the terminal 41b. This configuration highly precisely controls the reflection phase shift of the second harmonic wave to match the band being transferred.

In the present modification, the numerical values for forward phase, reflection phase, and reflection phase difference do not necessarily represent exact values but represent substantially the same values involving, for example, about 30% differences.

### 3 Configuration of Amplifier Circuit 10b According to Second Modification

An amplifier circuit 10B according to a second modification will be described. FIG. 6 is a circuit configuration diagram of the amplifier circuit 10B according to the second modification of the embodiment. As illustrated in the drawing, the amplifier circuit 10B includes power amplifiers 11 and 12, phase shifter circuits 21 and 22, harmonic phase shifter circuits 31B and 32B, the switching circuit 41, a 90° hybrid 50, phase shift lines 51 and 52, a capacitor 53, and a radio-frequency input terminal 110. The amplifier circuit 10B according to the present modification differs from the amplifier circuit 10 according to the embodiment in the circuit configuration of the harmonic phase shifter circuit. The following describes the amplifier circuit 10B according to the present modification, focusing on the harmonic phase shifter circuits 31B and 32B, which are different configurational features from the amplifier circuit 10 according to the embodiment, and descriptions of the same configurational features as the amplifier circuit 10 according to the embodiment will not be repeated.

The harmonic phase shifter circuit 31B is an example of a first harmonic phase shifter circuit. The harmonic phase shifter circuit 31B is coupled between the third output port of the power amplifier 11 and the terminal 41c of the switching circuit 41. In the present modification, one end of the harmonic phase shifter circuit 31B is coupled between the third output port of the power amplifier 11 and the connection point of the phase shift line 51 and the phase shifter circuit 21. The harmonic phase shifter circuit 31B is coupled near the third output port to suppress parasitic inductance and parasitic capacitance, because the reflection phase of the third harmonic wave at the third output port, which is in a higher frequency band, needs to be controlled with high precision. The harmonic phase shifter circuit 31B includes, for example, a third capacitor coupled between ground and the path connecting the third output port and the capacitor 211. The harmonic phase shifter circuit 31B operates as a low pass filter with a pass band that corresponds to the fundamental frequency ranges of the bands A and B. The forward phase of the fundamental waves is, for example, 0°.

The harmonic phase shifter circuit 32B is an example of a second harmonic phase shifter circuit. The harmonic phase shifter circuit 32B is coupled between the fourth output port of the power amplifier 12 and the terminal 41d of the switching circuit 41. In the present modification, one end of the harmonic phase shifter circuit 32B is coupled between the fourth output port of the power amplifier 12 and the connection point of the phase shift line 52 and the phase shifter circuit 22. The harmonic phase shifter circuit 32B is coupled near the fourth output port to suppress parasitic inductance and parasitic capacitance, because the reflection phase of the third harmonic wave at the fourth output port, which is in a higher frequency band, needs to be controlled with high precision. The harmonic phase shifter circuit 32B includes, for example, a third inductor and a fourth capacitor. The third inductor and the fourth capacitor form an LC circuit by being coupled in series with each other. The LC circuit is coupled between ground and the path connecting the fourth output port and the second inductor. The harmonic phase shifter circuit 32B operates as a notch filter with a pass band that corresponds to the fundamental frequency ranges of the bands A and B. The forward phase of the fundamental waves is, for example, 0°.

The phase shifter circuit 21 and the harmonic phase shifter circuit 31B are configured such that the forward phase of the third harmonic waves in the bands A and B in the circuit formed by combining the phase shifter circuit 21 and the harmonic phase shifter circuit 31B is +45° (a phase advance of 45°). The phase shifter circuit 22 and the harmonic phase shifter circuit 32B are configured such that the forward phase of the third harmonic waves in the circuit formed by combining the phase shifter circuit 22 and the harmonic phase shifter circuit 32B is −45° (a phase delay of 45°).

In the amplifier circuit 10B configured as described above, the phase shifter circuits 21 and 22 and the harmonic phase shifter circuits 31B and 32B are configured such that: the difference between the first reflection phase of the fundamental wave of the band-A transmit band assuming the terminal 41a is observed from the third output port and the second reflection phase of the fundamental wave of the band-A transmit band assuming the terminal 41a is observed from the fourth output port is 180°; and the difference between the third reflection phase of the third harmonic wave of the band-A transmit band assuming the terminal 41a is observed from the third output port and the fourth reflection phase of the third harmonic wave of the band-A transmit band assuming the terminal 41a is observed from the fourth output port is 180°.

The third reflection phase of the third harmonic wave of the band-A transmit band assuming the terminal 41a is observed from the third output port is defined as the phase shift of the third harmonic wave of the reflected signal reflected at the terminal 41a and returned to the third output port, relative to the phase of the third harmonic wave of the transmit signal in the band-A transmit band that is output from the third output port, in the state in which the terminal 41c is connected to the terminal 41a while the terminal 41a is disconnected from the filter 61. The fourth reflection phase of the third harmonic wave of the band-A transmit band assuming the terminal 41a is observed from the fourth output port is defined as the phase shift of the third harmonic wave of the reflected signal reflected at the terminal 41a and returned to the fourth output port, relative to the phase of the third harmonic wave of the transmit signal in the band-A transmit band that is output from the fourth output port, in the state in which the terminal 41d is connected to the terminal 41a while the terminal 41a is disconnected from the filter 61.

The third reflection phase of the third harmonic wave of the band-A transmit band can be obtained by measuring the reflection phase of the third harmonic wave of the band A at the terminal 41a in the state in which the terminal 41c is connected to the terminal 41a, the terminal 41d is disconnected from the terminal 41a, and the terminal 41a is disconnected from the filter 61. The third reflection phase of the third harmonic wave of the band-B transmit band can be obtained by measuring the reflection phase of the third harmonic wave of the band B at the terminal 41b in the state in which the terminal 41c is connected to the terminal 41b, the terminal 41d is disconnected from the terminal 41b, and the terminal 41b is disconnected from the filter 62.

The fourth reflection phase of the third harmonic wave of the band-A transmit band can be obtained by measuring the reflection phase of the third harmonic wave of the band A at the terminal 41a in the state in which the terminal 41d is connected to the terminal 41a, the terminal 41c is disconnected from the terminal 41a, and the terminal 41a is disconnected from the filter 61. The fourth reflection phase of the third harmonic wave of the band-B transmit band can be obtained by measuring the reflection phase of the third harmonic wave of the band B at the terminal 41b in the state in which the terminal 41d is connected to the terminal 41b, the terminal 41c is disconnected from the terminal 41b, and the terminal 41b is disconnected from the filter 62.

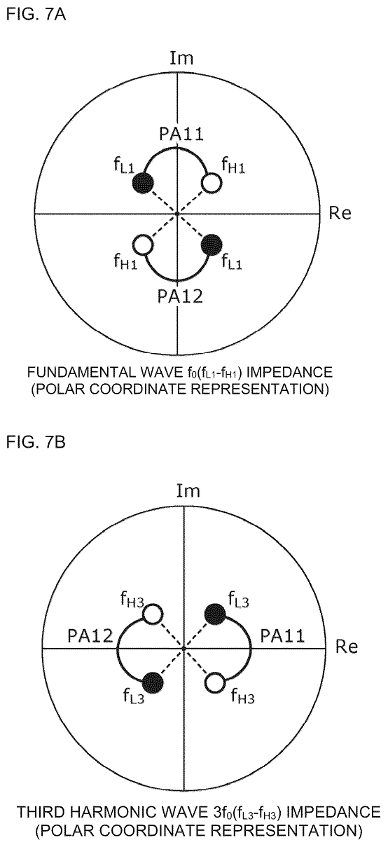

FIG. 7A illustrates the fundamental impedances of the power amplifiers 11 and 12 according to the second modification of the embodiment. FIG. 7B illustrates the third harmonic impedances of the power amplifiers 11 and 12 according to the second modification of the embodiment. FIG. 7A illustrates the impedance of the band-A fundamental wave (frequencies f_{L1} to f_{H1}) at the third output port of the power amplifier 11 (PA11) and the impedance of the band-A fundamental wave at the fourth output port of the power amplifier 12 (PA12) in polar coordinates. FIG. 7B illustrates the impedance of the band-A third harmonic wave (frequencies f_{L3} to f_{H3}) at the third output port of the power amplifier 11 (PA11) and the impedance of the band-A third harmonic wave at the fourth output port of the power amplifier 12 (PA12) in polar coordinates.

As illustrated in FIG. 7A, the difference between the first reflection phase of the fundamental wave and the second reflection phase of the fundamental wave is 180°. As a result, a consistent phase difference of 180° is maintained between the fundamental impedance of the power amplifier 11 and the fundamental impedance of the power amplifier 12 across the band-A fundamental frequency range (frequencies f_{L1} to f_{H1}). Thus, the radio-frequency circuit according to the present modification cancels out load variations in the band-A fundamental frequency range and achieves stable transmission output characteristics across the fundamental frequency range.

As illustrated in FIG. 7B, the difference between the third reflection phase of the third harmonic wave and the fourth reflection phase of the third harmonic wave is 180°. As a result, a consistent phase difference of 180° is maintained between the third harmonic impedance of the power amplifier 11 and the third harmonic impedance of the power amplifier 12 across the band-A third harmonic frequency range (frequencies f_{L3} to f_{H3}). Thus, the radio-frequency circuit according to the present modification cancels out load variations in the band-A third harmonic frequency range and achieves stable transmission output characteristics across the third harmonic frequency range.

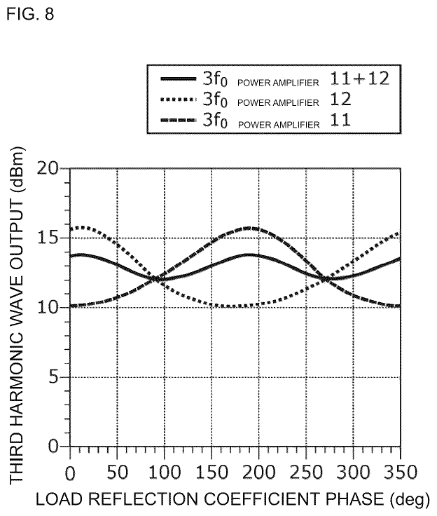

FIG. 8 is a graph illustrating the output characteristics of the third harmonic wave of the amplifier circuit 10B according to the second modification of the embodiment. As illustrated in the drawing, the third harmonic outputs of the power amplifiers 11 and 12 fluctuate with load variations (phase variations). However, because the difference between the third reflection phase of the third harmonic wave and the fourth reflection phase of the third harmonic wave is 180°, variations in the combined third harmonic output formed by combining the third harmonic waves from the power amplifiers 11 and 12 are suppressed. As a result, the amplifier circuit 10B achieves stable transmission output characteristics of the third harmonic wave, regardless of the presence of load variations.

As described above, in the amplifier circuit 10B and the radio-frequency circuit according to the present modification, assuming unwanted signals at the fundamental and third harmonic frequencies of the band-A transmit band leak into the radio-frequency circuit through the antenna connection terminal 100 from external circuits, the reflection phase difference between the fundamental waves observed from the output ports of the two balanced power amplifiers 11 and 12 is 180°, and the reflection phase difference of the third harmonic waves is also 180°. As a result, fluctuations in the transmission characteristics of the fundamental and harmonic frequency ranges of the radio-frequency circuit can be suppressed regardless of load variations. As such, the amplifier circuit 10B and the radio-frequency circuit are provided in the manner that mitigates fluctuations in the output characteristics of the fundamental and harmonic frequency ranges of transmit signals.

It may be noted that in the amplifier circuit 10B according to the present modification, either the harmonic phase shifter circuit 31B or 32B may be excluded. It is sufficient for the amplifier circuit according to the present disclosure to have a circuit configuration that achieves a 180° phase difference between the reflection phase of the third harmonic wave of the first signal in the path connecting the third output port of the power amplifier 11 and the terminal 41a (combining point) and the reflection phase of the third harmonic wave of the second signal in the path connecting the fourth output port of the power amplifier 12 and the terminal 41a.

In the amplifier circuit 10B according to the present modification, at least one of the phase shifter circuits 21 and 22 and the harmonic phase shifter circuits 31B and 32B may include a variable circuit having a variable forward phase. The circuit configurations illustrated in FIGS. 5A to 5D are examples of specific circuit configurations that include the above variable circuit. For example, the circuit state of the variable circuit can be changed depending on whether the amplifier circuit 10B according to the present modification transfers band-A or band-B transmit signals. In other words, at least one of the phase shifter circuits 21 and 22 and the harmonic phase shifter circuits 31B and 32B may be configured such that the forward phase of the fundamental wave and the third harmonic wave can be changed by alternating between connecting the terminals 41c and 41d to the terminal 41a and connecting the terminals 41c and 41d to the terminal 41b. This configuration highly precisely controls the reflection phase shift of the third harmonic wave to match the band being transferred.

In the present modification, the numerical values for forward phase, reflection phase, and reflection phase difference do not necessarily represent exact values but represent substantially the same values involving, for example, about 30% differences.

### 4 Configuration of Amplifier Circuit 10c According to Third Modification

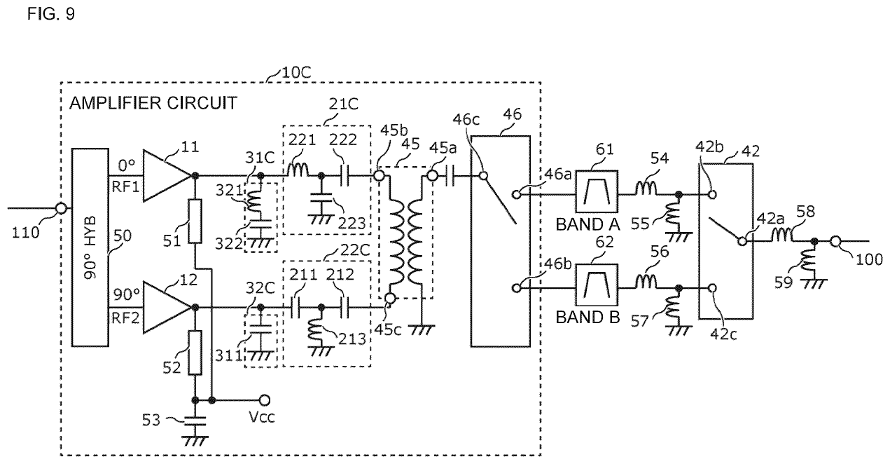

An amplifier circuit 10C according to a third modification will be described. FIG. 9 is a circuit configuration diagram of the amplifier circuit 10C and a radio-frequency circuit according to the third modification of the embodiment. As illustrated in the drawing, the amplifier circuit 10C includes power amplifiers 11 and 12, phase shifter circuits 21C and 22C, harmonic phase shifter circuits 31C and 32C, a transformer 45, a switching circuit 46, a 90° hybrid 50, phase shift lines 51 and 52, a capacitor 53, and a radio-frequency input terminal 110. The amplifier circuit 10C according to the present modification differs from the amplifier circuit 10 according to the embodiment primarily in incorporating the transformer 45. The following describes the amplifier circuit 10C according to the present modification with a main focus on configurational features different from the amplifier circuit 10 according to the embodiment, and descriptions of the same configurational features as the amplifier circuit 10 according to the embodiment will not be repeated. The radio-frequency circuit according to the present modification differs from the radio-frequency circuit 1 according to the embodiment in the configuration of the amplifier circuit.

The phase shifter circuit 21C is an example of a first phase shifter circuit. The phase shifter circuit 21C is coupled between the third output port of the power amplifier 11 and a terminal 45b of the transformer 45. The phase shifter circuit 21C includes, for example, an inductor 221 and capacitors 222 and 223. The inductor 221 is an example of a first inductor. The inductor 221 is coupled between the fourth output port and the terminal 45b. The capacitor 223 is an example of a first capacitor. The capacitor 223 is coupled between ground and the path connecting the inductor 221 and the terminal 45b. The capacitor 222 is provided in series in the path connecting the inductor 221 and the terminal 45b. The phase shifter circuit 21C is configured as a low pass filter. The phase shifter circuit 21C is operable to introduce, for example, a phase shift of −45° (a phase delay of 45°) to the forward phase of the fundamental signals in the bands A and B. The capacitor 222 is a DC blocking capacitor and does not contribute to phase shift. The capacitor 222 is not necessarily included in the phase shifter circuit 21C.

The phase shifter circuit 22C is an example of a second phase shifter circuit. The phase shifter circuit 22C is coupled between the fourth output port of the power amplifier 12 and a terminal 45c of the transformer 45. The phase shifter circuit 22C is configured such that the forward phase of the fundamental waves in the bands A and B is +90° (a phase advance of 90°) relative to the phase shifter circuit 21C. The phase shifter circuit 22C includes, for example, capacitors 211 and 212 and an inductor 213. The capacitor 211 is an example of a second capacitor. The capacitor 211 is coupled between the third output port and the terminal 45c. The inductor 213 is an example of a second inductor. The inductor 213 is coupled between ground and the path connecting the capacitor 211 and the terminal 45c. The capacitor 212 is provided in series in the path connecting the capacitor 211 and the terminal 45c. The phase shifter circuit 22C is configured as a high pass filter. The phase shifter circuit 22C is operable to introduce, for example, a phase shift of +450 (a phase advance of 45°) to the forward phase of the fundamental waves in the bands A and B. The capacitor 212 is a DC blocking capacitor and does not contribute to phase shift. The capacitor 212 is not necessarily included in the phase shifter circuit 22C.

The harmonic phase shifter circuit 31C is an example of a first harmonic phase shifter circuit. The harmonic phase shifter circuit 31C is coupled between the third output port of the power amplifier 11 and the terminal 45b of the transformer 45. The harmonic phase shifter circuit 31C includes, for example, an inductor 321 and a capacitor 322. The inductor 321 (a third inductor) and the capacitor 322 (a third capacitor) form an LC circuit by being coupled in series with each other. The LC circuit is coupled between ground and the path connecting the third output port and the inductor 221. The harmonic phase shifter circuit 31C operates as a notch filter with a pass band that corresponds to the fundamental frequency ranges of the bands A and B. The forward phase of the fundamental waves is, for example, 0°.

The harmonic phase shifter circuit 32C is an example of a second harmonic phase shifter circuit. The harmonic phase shifter circuit 32C is coupled between the fourth output port of the power amplifier 12 and the terminal 45c of the transformer 45. The harmonic phase shifter circuit 32C includes, for example, a capacitor 311 (a fourth capacitor) coupled between ground and the path connecting the fourth output port and the capacitor 211. The harmonic phase shifter circuit 32C operates as a low pass filter with a pass band that corresponds to the fundamental frequency ranges of the bands A and B. The forward phase of the fundamental waves is, for example, 0°.

The phase shifter circuit 21C and the harmonic phase shifter circuit 31C are configured such that the forward phase of the second harmonic waves in the bands A and B in the circuit formed by combining the phase shifter circuit 21C and the harmonic phase shifter circuit 31C is −45° (a phase delay of 45°). The phase shifter circuit 22C and the harmonic phase shifter circuit 32C are configured such that the forward phase of the second harmonic waves in the circuit formed by combining the phase shifter circuit 22C and the harmonic phase shifter circuit 32C is +45° (a phase advance of 45°).

The transformer 45 is an example of a combiner circuit. The transformer 45 includes a primary coil, a secondary coil, a terminal 45a (a fifth output port), which is one end of the primary coil, the terminal 45b (a fourth input port), which is the other end of the primary coil, and the terminal 45c (a fifth input port), which is one end of the secondary coil. The transformer 45 is operable to combine in antiphase the third split signal input from the terminal 45b and the fourth split signal input from the terminal 45c and output the generated output signal from the terminal 45a. The transformer 45 serves as the signal combining point for combining in antiphase the band-A third split signal and the band-A fourth split signal and combining in antiphase the band-B third split signal and the band-B fourth split signal.

The switching circuit 46 operates as a band alteration switch. The switching circuit 46 has terminals 46a, 46b, and 46c. The switching circuit 46 is operable to alternate between connecting the terminals 46a and 46b and connecting the terminals 46a and 46c.

With the configuration described above, a band-A transmit signal is split by the 90° hybrid 50 into the first split signal RF1 and the second split signal RF2. The first split signal RF1 and the second split signal RF2 are respectively input to the power amplifiers 11 and 12 and amplified into a first signal and a second signal. At the third output port of the power amplifier 11, the phase of the fundamental wave of the first signal is 0°. At the fourth output port of the power amplifier 12, the phase of the fundamental wave of the second signal is 90°.

After the first signal passes through the harmonic phase shifter circuit 31C (with a fundamental-wave forward phase of 0°) and the phase shifter circuit 21C (with a fundamental-wave forward phase of −45°), the phase of the fundamental wave of the first signal is −45° at the terminal 45b. After the second signal passes through the harmonic phase shifter circuit 32C (with a fundamental-wave forward phase of 0°) and the phase shifter circuit 22C (with a fundamental-wave forward phase of +45°), the phase of the fundamental wave of the second signal is +1350 at the terminal 45c. As a result, the band-A first signal and the band-A second signal can be combined in antiphase at the transformer 45. This configuration enables highly efficient power combining of the fundamental wave with respect to load variations.

The difference between the first reflection phase (−45°×2=−90°) of the fundamental wave of the first signal assuming the terminal 45b is observed from the third output port and the second reflection phase (45°×2=+90°) of the fundamental wave of the second signal assuming the terminal 45c is observed from the fourth output port is 1800.

The forward phase of the second harmonic wave of the first signal in the circuit formed by combining the harmonic phase shifter circuit 31C and the phase shifter circuit 21C is −45°. The forward phase of the second harmonic wave of the second signal in the circuit formed by combining the harmonic phase shifter circuit 32C and the phase shifter circuit 22C is +45°. In other words, the difference between the third reflection phase (−45°×2=−90°) of the second harmonic wave of the first signal assuming the terminal 45b is observed from the third output port and the fourth reflection phase (45°×2=+90°) of the second harmonic wave of the second signal assuming the terminal 45c is observed from the fourth output port is 1800.

In the amplifier circuit 10C configured as described above, the phase shifter circuits 21C and 22C and the harmonic phase shifter circuits 31C and 32C are configured such that: the difference between the first reflection phase of the fundamental wave of the band-A transmit band assuming the terminal 45b is observed from the third output port and the second reflection phase of the fundamental wave of the band-A transmit band assuming the terminal 45c is observed from the fourth output port is 180°; and the difference between the third reflection phase of the second harmonic wave of the band-A transmit band assuming the terminal 45b is observed from the third output port and the fourth reflection phase of the second harmonic wave of the band-A transmit band assuming the terminal 45c is observed from the fourth output port is 180°.

With the configuration described above, assuming unwanted signals at the fundamental and second harmonic frequencies of the band-A transmit band leak into the radio-frequency circuit through the antenna connection terminal 100 from external circuits, the reflection phase difference between the fundamental waves observed from the output ports of the two balanced power amplifiers 11 and 12 is 180°, and the reflection phase difference of the second harmonic waves is also 180°. As a result, fluctuations in the transmission characteristics of the fundamental and harmonic frequency ranges of the radio-frequency circuit can be suppressed regardless of load variations. As such, the amplifier circuit 10C and the radio-frequency circuit are provided in the manner that mitigates fluctuations in the output characteristics of the fundamental and harmonic frequency ranges of transmit signals.

It may be noted that in the amplifier circuit 10C according to the present modification, either the harmonic phase shifter circuit 31C or 32C may be excluded. It is sufficient for the amplifier circuit according to the present disclosure to have a circuit configuration that achieves a 180° phase difference between the reflection phase of the second harmonic wave of the first signal in the path connecting the third output port of the power amplifier 11 and the terminal 45b and the reflection phase of the second harmonic wave of the second signal in the path connecting the fourth output port of the power amplifier 12 and the terminal 45c.

In the amplifier circuit 10C according to the present modification, the phase shifter circuits 21C and 22C and the harmonic phase shifter circuits 31C and 32C may be configured such that: the difference between the first reflection phase of the fundamental wave of the band-A transmit band assuming the terminal 45b is observed from the third output port and the second reflection phase of the fundamental wave of the band-A transmit band assuming the terminal 45c is observed from the fourth output port is 180°; and the difference between the third reflection phase of the third harmonic wave of the band-A transmit band assuming the terminal 45b is observed from the third output port and the fourth reflection phase of the third harmonic wave of the band-A transmit band assuming the terminal 45c is observed from the fourth output port is 180°.

With the configuration described above, assuming unwanted signals at the fundamental and third harmonic frequencies of the band-A transmit band leak into the radio-frequency circuit through the antenna connection terminal 100 from external circuits, the reflection phase difference between the fundamental waves observed from the output ports of the two balanced power amplifiers 11 and 12 is 180°, and the reflection phase difference of the third harmonic waves is also 180°. As a result, fluctuations in the transmission characteristics of the fundamental and harmonic frequency ranges of the radio-frequency circuit can be suppressed regardless of load variations.

In the present modification, the numerical values for forward phase, reflection phase, and reflection phase difference do not necessarily represent exact values but represent substantially the same values involving, for example, about 30% differences.

### 5 Configuration of Amplifier Circuit, Radio-Frequency Circuit, and Communication Device According to Fourth Modification

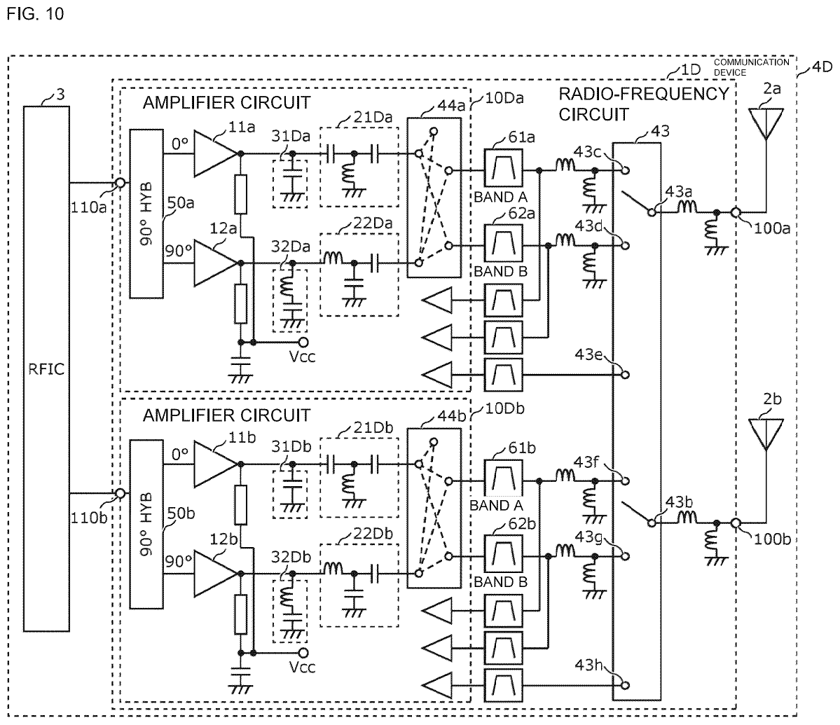

Amplifier circuits 10Da and 10Db, a radio-frequency circuit 1D, and a communication device 4D according to a fourth modification will be described. FIG. 10 is a circuit configuration diagram of the amplifier circuits 10Da and 10Db, the radio-frequency circuit 1D, and the communication device 4D according to the fourth modification of the embodiment. As illustrated in the drawing, the communication device 4D according to the present modification includes the radio-frequency circuit 1D, antennas 2a and 2b, and an RFIC 3.

The antenna 2a is coupled to an antenna connection terminal 100a (a first antenna terminal) of the radio-frequency circuit 1D. The antenna 2a is operable to transmit radio-frequency signals outputted from the radio-frequency circuit 1D and to receive radio-frequency signals from outside and output the radio-frequency signals to the radio-frequency circuit 1D.

The antenna 2b is coupled to an antenna connection terminal 100b (a second antenna terminal) of the radio-frequency circuit 1D. The antenna 2b is operable to transmit radio-frequency signals outputted from the radio-frequency circuit 1D and to receive radio-frequency signals from outside and output the radio-frequency signals to the radio-frequency circuit 1D.

The radio-frequency circuit 1D includes amplifier circuits 10Da and 10Db, filters 61a, 61b, 62a, and 62b, a switching circuit 43, and the antenna connection terminals 100a and 100b. The radio-frequency circuit 1D according to the present modification differs from the radio-frequency circuit 1 according to the embodiment primarily in additionally incorporating a receive circuit and incorporating two amplifier circuits. The following describes the radio-frequency circuit 1D according to the present modification with a main focus on configurational features different from the radio-frequency circuit 1 according to the embodiment, and descriptions of the same configurational features as the radio-frequency circuit 1 according to the embodiment will not be repeated.

The amplifier circuit 10Da includes power amplifiers 11a and 12a, phase shifter circuits 21Da and 22Da, harmonic phase shifter circuits 31Da and 32Da, a switching circuit 44a, a 90° hybrid 50a, and a radio-frequency input terminal 110a. The amplifier circuit 10Da has the same circuit configuration as the amplifier circuit 10 according to the embodiment. The phase shifter circuits 21Da and 22Da and the harmonic phase shifter circuits 31Da and 32Da are configured such that: the difference between the first reflection phase of the fundamental wave of the band-A transmit band assuming the switching circuit 44a is observed from the output port of the power amplifier 11a and the second reflection phase of the fundamental wave of the band-A transmit band assuming the switching circuit 44a is observed from the output port of the power amplifier 12a is 180°; and the difference between the third reflection phase of the second harmonic wave of the band-A transmit band assuming the switching circuit 44a is observed from the output port of the power amplifier 11a and the fourth reflection phase of the second harmonic wave of the band-A transmit band assuming the switching circuit 44a is observed from the output port of the power amplifier 12a is 180°.

The amplifier circuit 10Db includes power amplifiers 11b and 12b, phase shifter circuits 21Db and 22Db, harmonic phase shifter circuits 31Db and 32Db, a switching circuit 44b, a 90° hybrid 50b, and a radio-frequency input terminal 110b. The power amplifiers 11b and 12b are an example of a third power amplifier. The amplifier circuit 10Db has the same circuit configuration as the amplifier circuit 10 according to the embodiment. The phase shifter circuits 21Db and 22Db and the harmonic phase shifter circuits 31Db and 32Db are configured such that: the difference between the first reflection phase of the fundamental wave of the band-A transmit band assuming the switching circuit 44b is observed from the output port of the power amplifier 11b and the second reflection phase of the fundamental wave of the band-A transmit band assuming the switching circuit 44b is observed from the output port of the power amplifier 12b is 180°; and the difference between the third reflection phase of the second harmonic wave of the band-A transmit band assuming the switching circuit 44b is observed from the output port of the power amplifier 11b and the fourth reflection phase of the second harmonic wave of the band-A transmit band assuming the switching circuit 44b is observed from the output port of the power amplifier 12b is 180°.

The filter 61a is an example of a first filter. The filter 61a is coupled between the switching circuit 44a and the antenna connection terminal 100a. The filter 61a has a pass band that includes the band A. Specifically, one end of the filter 61a is coupled to the switching circuit 44a, and the other end of the filter 61a is coupleable to the antenna connection terminal 100a via the switching circuit 43. As illustrated in FIG. 10, receive filters having pass bands that include the band A and low-noise amplifiers may be coupled to the node in the path connecting the filter 61a and the switching circuit 43.

The filter 62a is an example of a second filter. The filter 62a is coupled between the switching circuit 44a and the antenna connection terminal 100a. The filter 62a has a pass band that includes the band B. Specifically, one end of the filter 62a is coupled to the switching circuit 44a, and the other end of the filter 62a is coupleable to the antenna connection terminal 100a via the switching circuit 43. As illustrated in FIG. 10, receive filters having pass bands that include the band B and low-noise amplifiers may be coupled to the node in the path connecting the filter 62a and the switching circuit 43.

The filter 61b is an example of a third filter. The filter 61b is coupled between the switching circuit 44b and the antenna connection terminal 100b. The filter 61b has a pass band that includes the band A. Specifically, one end of the filter 61b is coupled to the switching circuit 44b, and the other end of the filter 61b is coupleable to the antenna connection terminal 100b via the switching circuit 43. As illustrated in FIG. 10, receive filters having pass bands that include the band A and low-noise amplifiers may be coupled to the node in the path connecting the filter 61b and the switching circuit 43.

The filter 62b is an example of a second filter. The filter 62b is coupled between the switching circuit 44b and the antenna connection terminal 100b. The filter 62b has a pass band that includes the band B. Specifically, one end of the filter 62b is coupled to the switching circuit 44b, and the other end of the filter 62b is coupleable to the antenna connection terminal 100b via the switching circuit 43. As illustrated in FIG. 10, receive filters having pass bands that include the band B and low-noise amplifiers may be coupled to the node in the path connecting the filter 62b and the switching circuit 43.

The switching circuit 43 is an example of an antenna switch. The switching circuit 43 has terminals 43a, 43b, 43c, 43d, 43e, 43f, 43g, and 43h. The terminal 43a is coupled to the antenna connection terminal 100a. The terminal 43b is coupled to the antenna connection terminal 100b. The terminal 43c is coupled to the filter 61a. The terminal 43d is coupled to the filter 62a. The terminal 43f is coupled to the filter 61b. The terminal 43g is coupled to the filter 62b. With the configuration described above, the switching circuit 43 is operable to alternate the connection and disconnection between the antenna connection terminal 100a and the filter 61a, the connection and disconnection between the antenna connection terminal 100a and the filter 62a, the connection and disconnection between the antenna connection terminal 100b and the filter 61b, and the connection and disconnection between the antenna connection terminal 100b and the filter 62b. The switching circuit 43 is able to couple the antenna connection terminal 100a to the filter 61a while also coupling the antenna connection terminal 100b to the filter 61b. The switching circuit 43 is able to couple the antenna connection terminal 100a to the filter 62a while also coupling the antenna connection terminal 100b to the filter 62b. This means that the communication device 4D is able to output from the antenna 2a band-A transmit signals output from the amplifier circuit 10Da, while outputting from the antenna 2b band-A transmit signals output from the amplifier circuit 10Db. The communication device 4D is able to output from the antenna 2a band-B transmit signals output from the amplifier circuit 10Da, while outputting from the antenna 2b band-B transmit signals output from the amplifier circuit 10Db.

With this configuration, band-A transmit signals output from the amplifier circuit 10Db may leak into the amplifier circuit 10Da through the antenna connection terminal 100b (the antenna 2b) and the antenna connection terminal 100a (the antenna 2a). Also in this case, the reflection phase difference of the band-A fundamental and harmonic waves assuming observed from the output ports of the balanced power amplifiers 11a and 11b is 180°. Thus, load variations in the fundamental and harmonic frequency ranges can be suppressed. As such, the radio-frequency circuit 1D is provided in the manner that mitigates fluctuations in the output characteristics of the fundamental and harmonic frequency ranges of transmit signals.

In the present modification, the numerical values for forward phase, reflection phase, and reflection phase difference do not necessarily represent exact values but represent substantially the same values involving, for example, about 30% differences.

### 6 Component Layout of Amplifier Circuit 10

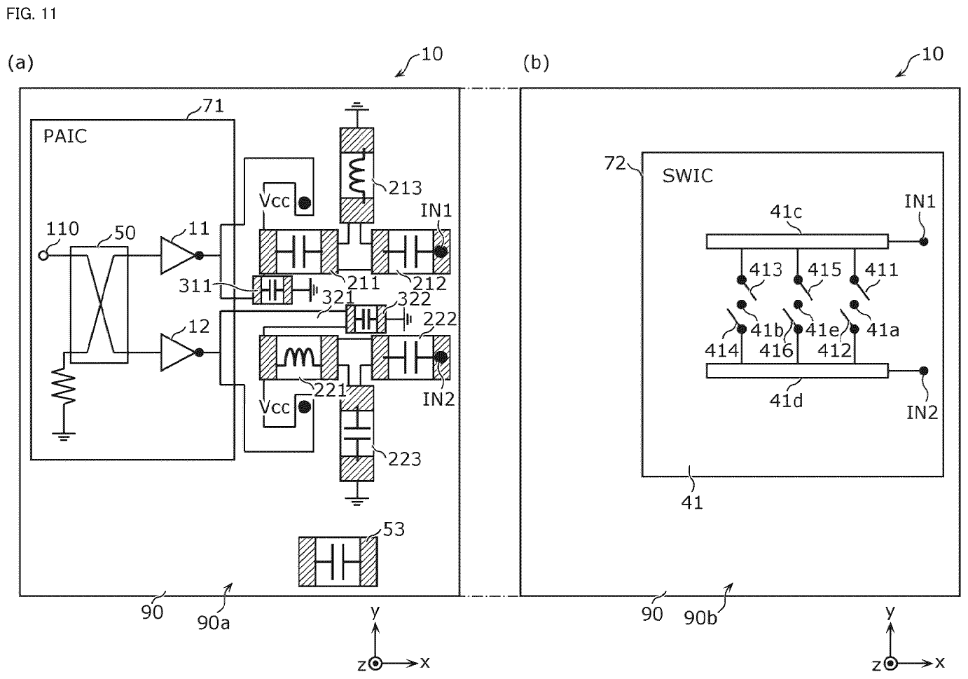

Next, a component layout of the amplifier circuit 10 according to the embodiment will be described. FIG. 11 provides plan views of the amplifier circuit 10 according to the embodiment. In FIG. 11, (a) illustrates a layout of circuit components assuming a major surface 90a of a mounting substrate 90 is viewed from the front side in the positive direction of the z-axis. In FIG. 11, (b) is a cutaway view of the layout of circuit components assuming a major surface 90b of the mounting substrate 90 is viewed from the front side in the positive direction of the z-axis. In FIG. 11, some wires connecting the mounting substrate 90 and the circuit components are not illustrated.

The amplifier circuit 10 illustrated in FIG. 11 includes the mounting substrate 90 for the amplifier circuit 10 illustrated in FIG. 1.

The mounting substrate 90 has the major surfaces 90a and 90b that are opposite to each other. The circuit components constituting the amplifier circuit 10 are mounted at the mounting substrate 90. For example, a low temperature co-fired ceramics (LTCC) substrate having a layered structure of a plurality of dielectric layers, a high temperature co-fired ceramics (HTCC) substrate, a component-embedded substrate, a substrate including a redistribution layer (RDL), or a printed-circuit board is used as the mounting substrate 90.

As illustrated in FIG. 11, the 90° hybrid 50, the power amplifiers 11 and 12, the inductors 213, 221 and 321, and the capacitors 211, 212, 222, 223, 311, 322, and 53 are disposed at the major surface 90a. The switching circuit 41 is disposed at the major surface 90b.

In this arrangement, the circuit components are disposed separately at the major surface 90a or 90b of the mounting substrate 90. This arrangement thus reduces the size of the amplifier circuit 10.

The 90° hybrid 50 and the power amplifiers 11 and 12 are included in a semiconductor integrated circuit (IC) 71. The switching circuit 41 is included in a semiconductor IC 72.

In this arrangement, the 90° hybrid 50 and the power amplifiers 11 and 12 are formed as a single chip, and the switching circuit 41 is formed as a single chip. This arrangement thus reduces the size of the amplifier circuit 10.

The semiconductor ICs 71 and 72 are made using, for example, complementary metal oxide semiconductor (CMOS). Specifically, the semiconductor ICs 71 and 72 may be manufactured using a silicon on insulator (SOI) process. The semiconductor ICs 71 and 72 may be made from at least one of GaAs, SiGe, and GaN. The semiconductor material of the semiconductor ICs 71 and 72 is not limited to the materials presented above.

The switching circuit 41 includes the terminals 41a, 41b, 41c, 41d, and 41e and switches 411, 412, 413, 414, 415, and 416.

The switch 411 is an example of a first switch. The switch 411 is coupled between the terminals 41c and 41a. The switch 413 is an example of a second switch. The switch 413 is coupled between the terminals 41c and 41b. The switch 412 is an example of a third switch. The switch 412 is coupled between the terminals 41d and 41a. The switch 414 is an example of a fourth switch. The switch 414 is coupled between the terminals 41d and 41b. The switch 415 is coupled between the terminals 41e and 41c. The switch 416 is coupled between the terminals 41e and 41d.

Assuming the major surface of the semiconductor IC 72 is viewed in plan view, the switches 411 and 412 are positioned between the terminals 41c and 41d, and the terminal 41a is positioned between the switches 411 and 412. The switches 413 and 414 are positioned between the terminals 41c and 41d, and the terminal 41b is positioned between the switches 413 and 414.

In this configuration, the line length from the terminal 41c to the terminal 41a and the line length from the terminal 41d to the terminal 41a, which carry band-A signals, are equal; the line length from the terminal 41c to the terminal 41b and the line length from the terminal 41d to the terminal 41b, which carry band-B signals, are also equal. This configuration helps highly precisely set the difference between the reflection phase from the third output port of the power amplifier 11 to the terminal 41a and the reflection phase from the fourth output port of the power amplifier 12 to the terminal 41a. This configuration also helps highly precisely set the difference between the reflection phase from the third output port of the power amplifier 11 to the terminal 41b and the reflection phase from the fourth output port of the power amplifier 12 to the terminal 41b.

The amplifier circuit according to the first modification has the same component layout illustrated in FIG. 11, except that the first variable circuit of the phase shifter circuit 21A is included in the semiconductor IC 72 and coupled to the terminal 41c, while the second variable circuit of the phase shifter circuit 22A is included in the semiconductor IC 72 and coupled to the terminal 41d.

In this configuration, the variable circuits of the phase shifter circuits 21A and 22A can be included in the semiconductor IC 72 having the switching circuit 41. This configuration reduces the size of the amplifier circuit and the radio-frequency circuit.

Additionally, the third variable circuit of the harmonic phase shifter circuit 31A is included in the semiconductor IC 72. The fourth variable circuit of the harmonic phase shifter circuit 32A is included in the semiconductor IC 72.

In this configuration, the variable circuits of the harmonic phase shifter circuit 31A and 32A can be included in the semiconductor IC 72 having the switching circuit 41. This configuration reduces the size of the amplifier circuit and the radio-frequency circuit.

### 7 Effects

As described above, the radio-frequency circuit 1 according to the present embodiment includes the antenna connection terminal 100, the 90° hybrid 50 configured to split a fundamental signal of the transmit band of the band A that are input to the first input port, output the first split signal from the first output port, and output the second split signal, which has a phase of +90° relative to the first split signal, from the second output port, the power amplifier 11 having the second input port and the third output port, the second input port being coupled to the first output port, the power amplifier 12 having the third input port and the fourth output port, the third input port being coupled to the second output port, the combiner circuit having the fourth input port, the fifth input port, and the fifth output port, configured to combine in phase the third split signal input from the fourth input port and the fourth split signal input from the fifth input port to generate an output signal and configured to output the output signal from the fifth output port, the phase shifter circuit 21 coupled between the third output port and the fourth input port, the phase shifter circuit 22 coupled between the fourth output port and the fifth input port, the harmonic phase shifter circuit 31 coupled between the third output port and the fourth input port and/or the harmonic phase shifter circuit 32 coupled between the fourth output port and the fifth input port, and the filter 61 coupled between the fifth output port and the antenna connection terminal 100, having a pass band that includes the transmit band. The phase shifter circuits 21 and 22 are configured such that the forward phase of the fundamental wave of the transmit band in the phase shifter circuit 22 in the direction from the fourth output port to the fifth input port is −90° relative to the forward phase of the fundamental wave in the phase shifter circuit 21 in the direction from the third output port to the fourth input port. The phase shifter circuits 21 and 22 and the harmonic phase shifter circuits 31 and 32 are configured such that: the difference between the first reflection phase of the fundamental wave assuming the fifth output port is observed from the third output port and the second reflection phase of the fundamental wave assuming the fifth output port is observed from the fourth output port is 180°; and the difference between the third reflection phase of at least one of the harmonic waves of the transmit band assuming the fifth output port is observed from the third output port and the fourth reflection phase of the at least one of the harmonic waves of the transmit band assuming the fifth output port is observed from the fourth output port is 180°.

With the configuration described above, assuming unwanted signals at the fundamental and second harmonic frequencies of the band-A transmit band leak into the radio-frequency circuit 1 through the antenna connection terminal 100 from external circuits, the reflection phase difference between the fundamental waves observed from the output ports of the two balanced power amplifiers 11 and 12 is 180°, and the reflection phase difference of the second harmonic waves is also 180°. As a result, fluctuations in the transmission characteristics of the fundamental and harmonic frequency ranges of the radio-frequency circuit 1 can be suppressed regardless of load variations. As such, the amplifier circuit 10 and the radio-frequency circuit 1 are provided in the manner that mitigates fluctuations in transmission characteristics caused by load variations.

In an example, in the radio-frequency circuit 1, the harmonic wave corresponds to the second harmonic wave having a frequency twice the fundamental wave.

With this configuration, the radio-frequency circuit 1 is provided in the manner that mitigates fluctuations in the output characteristics of the fundamental and second harmonic frequency ranges of transmit signals.

In an example, in the radio-frequency circuit according to the second modification, the harmonic wave corresponds to the third harmonic wave having a frequency three times the fundamental wave.

With this configuration, the radio-frequency circuit is provided in the manner that mitigates fluctuations in the output characteristics of the fundamental and third harmonic frequency ranges of transmit signals.

In an example, in the radio-frequency circuit 1, the phase shifter circuit 21 is configured such that the forward phase of the fundamental wave is +45°. The phase shifter circuit 22 is configured such that the forward phase of the fundamental wave is −45°. The phase shifter circuit 21 and the harmonic phase shifter circuit 31 are configured such that the forward phase of the harmonic wave in the circuit formed by combining the phase shifter circuit 21 and the harmonic phase shifter circuit 31 is +45°. The phase shifter circuit 22 and the harmonic phase shifter circuit 32 are configured such that the forward phase of the harmonic wave in the circuit formed by combining the phase shifter circuit 22 and the harmonic phase shifter circuit 32 is −45°.

With this configuration, the first signal and the second signal, which are two band-A radio-frequency signals, can be combined in phase at the fifth output port. This configuration enables highly efficient power combining of the fundamental wave with respect to load variations. This configuration achieves a 180° difference between the first reflection phase (+45°×2=90°) of the fundamental wave of the first signal assuming the fifth output port is observed from the third output port and the second reflection phase (−45°×2=−90°) of the fundamental wave of the second signal assuming the fifth output port is observed from the fourth output port. This configuration achieves a 180° difference between the third reflection phase (+45°×2=90°) of the second harmonic wave of the first signal assuming the fifth output port is observed from the third output port and the fourth reflection phase (−45°×2=−90°) of the second harmonic wave of the second signal assuming the fifth output port is observed from the fourth output port.

In an example, in the radio-frequency circuit 1, the phase shifter circuit 21 includes the capacitor 211 coupled between the third output port and the fourth input port, and the inductor 213 coupled between ground and the path connecting the capacitor 211 and the fourth input port. The phase shifter circuit 22 includes the inductor 221 coupled between the fourth output port and the fifth input port, and the capacitor 223 coupled between ground and the path connecting the inductor 221 and the fifth input port.

With this configuration, the phase shifter circuit 21 is configured as a high pass filter. This configuration achieves a +45° forward phase of the fundamental wave of the band A. The phase shifter circuit 22 is configured as a low pass filter. This configuration achieves a −45° forward phase of the fundamental wave of the band A.

In an example, in the radio-frequency circuit 1, the harmonic phase shifter circuit 31 includes the capacitor 311 coupled between ground and the path connecting the third output port and the capacitor 211. The harmonic phase shifter circuit 32 includes an LC circuit including the inductor 321 and the capacitor 322 that are coupled in series with each other. The LC circuit is coupled between ground and the path connecting the fourth output port and the inductor 221.

With this configuration, the harmonic phase shifter circuit 31 operates as a low pass filter with a pass band that corresponds to the fundamental frequency range of the band A. This configuration achieves a 0° forward phase of the fundamental wave of the band A. The harmonic phase shifter circuit 32 operates as a notch filter with a pass band that corresponds to the fundamental frequency range. This configuration achieves a 0° forward phase of the fundamental wave.

In an example, the radio-frequency circuit 1 further includes the filter 62 having a pass band that includes the band-B transmit band. The combiner circuit includes the switching circuit 41 having the terminal 41c (the fourth input port), the terminal 41d (the fifth input port), the terminal 41a (the fifth output port), and the terminal 41b (the sixth output port), configured to alternate between connecting the terminals 41c and 41a as well as connecting the terminals 41d and 41a and connecting the terminals 41c and 41b as well as connecting the terminals 41d and 41b. The filter 62 is coupled to the terminal 41b.

With this configuration, the radio-frequency circuit 1 is provided in the manner that supports multiple bands and enables outputting band-A transmit signals and band-B transmit signals. Furthermore, the terminals 41a and 41b of the switching circuit 41 serve as signal combining points, and the switching circuit also serves as a combiner circuit. This configuration reduces the size of the radio-frequency circuit 1.

In an example, in the radio-frequency circuit 1, the switching circuit 41 is included in the semiconductor IC 72. The switching circuit 41 includes the switch 411 coupled to the terminals 41c and 41a, the switch 413 coupled to the terminals 41c and 41b, the switch 412 coupled to the terminals 41d and 41a, and the switch 414 coupled to the terminals 41d and 41b. Assuming the major surface of the semiconductor IC 72 is viewed in plan view, the switches 411 and 412 are positioned between the terminals 41c and 41d, the terminal 41a is positioned between the switches 411 and 412, the switches 413 and 414 are positioned between the terminals 41c and 41d, and the terminal 41b is positioned between the switches 413 and 414.

In this configuration, the line length from the terminal 41c to the terminal 41a and the line length from the terminal 41d to the terminal 41a, which carry band-A signals, are equal; the line length from the terminal 41c to the terminal 41b and the line length from the terminal 41d to the terminal 41b, which carry band-B signals, are also equal. This configuration helps highly precisely set the difference between the reflection phase from the third output port of the power amplifier 11 to the terminal 41a and the reflection phase from the fourth output port of the power amplifier 12 to the terminal 41a. This configuration also helps highly precisely set the difference between the reflection phase from the third output port of the power amplifier 11 to the terminal 41b and the reflection phase from the fourth output port of the power amplifier 12 to the terminal 41b.

In an example, in the radio-frequency circuit 1, the switching circuit 41 further includes the terminal 41e. The terminal 41e is coupleable to the terminal 41c in the state in which the terminal 41c is disconnected from the terminals 41a and 41b or coupleable to the terminal 41d in the state in which the terminal 41d is disconnected from the terminals 41a and 41b.

With this configuration, the reflection phase of the fundamental and second harmonic waves of the band A or B can be measured at the terminal 41e.

In an example, in the radio-frequency circuit according to the second modification, at least one of the phase shifter circuits 21A and 22A is configured such that the forward phase can be changed by alternating between connecting the terminals 41c and 41d to the terminal 41a and connecting the terminals 41c and 41d to the terminal 41b.

This configuration highly precisely controls the reflection phase shift of the fundamental wave to match the band being transferred.

In an example, in the radio-frequency circuit according to the second modification, the switching circuit 41 is included in the semiconductor IC 72. The phase shifter circuit 21A includes the first variable circuit having the switch 215 and at least one of an inductor and a capacitor coupled to the switch 215. The phase shifter circuit 22A includes the second variable circuit having the switch 225 and at least one of an inductor and a capacitor coupled to the switch 225. The first variable circuit is coupled to the terminal 41c and included in the semiconductor IC 72. The second variable circuit is coupled to the terminal 41d and included in the semiconductor IC 72.

In this configuration, the variable circuits of the phase shifter circuits 21A and 22A can be included in the semiconductor IC 72 having the switching circuit 41. This configuration reduces the size of the amplifier circuit and the radio-frequency circuit.

In an example, in the radio-frequency circuit according to the second modification, at least one of the harmonic phase shifter circuits 31A and 32A is configured such that the forward phase can be changed by alternating between connecting the terminals 41c and 41d to the terminal 41a and connecting the terminals 41c and 41d to the terminal 41b.

This configuration highly precisely controls the reflection phase shift of the second harmonic wave to match the band being transferred.

In an example, in the radio-frequency circuit according to the second modification, the switching circuit 41 is included in the semiconductor IC 72. The harmonic phase shifter circuit 31A includes the third variable circuit having the switch 313 and at least one of an inductor and a capacitor coupled to the switch 313. The harmonic phase shifter circuit 32A includes the fourth variable circuit having the switch 324 and at least one of an inductor and a capacitor coupled to the switch 324. The third variable circuit and the fourth variable circuit are included in the semiconductor IC 72.

In this configuration, the variable circuits of the harmonic phase shifter circuit 31A and 32A can be included in the semiconductor IC 72 having the switching circuit 41. This configuration reduces the size of the amplifier circuit and the radio-frequency circuit.

In an example, the radio-frequency circuit 1D according to the fourth modification includes the antenna connection terminals 100a and 100b, the amplifier circuit 10Da coupled to the antenna connection terminal 100a and including the power amplifiers 11a and 12a, the amplifier circuit 10Db coupled to the antenna connection terminal 100b and including the power amplifiers 11b and 12b, the filter 61a coupled between the antenna connection terminal 100a and the amplifier circuit 10Da, and the filter 61b coupled between the antenna connection terminal 100b and the amplifier circuit 10Db.

With this configuration, assuming the band A transmit signals output from the amplifier circuit 10Db leak into the amplifier circuit 10Da through the antenna connection terminals 100b and 100a, the reflection phase difference between the band-A fundamental wave and the band-A harmonic wave assuming observed from the output ports of the balanced power amplifiers 11a and 11b is 180°. This configuration thus suppresses load variations in the fundamental and harmonic frequency ranges. As such, the radio-frequency circuit 1D is provided in the manner that mitigates fluctuations in the output characteristics of the fundamental and harmonic frequency ranges of transmit signals.

The radio-frequency circuit according to the third modification includes the antenna connection terminal 100, the 90° hybrid 50 configured to split a fundamental signal of the transmit band of the band A that are input to the first input port, output the first split signal from the first output port, and output the second split signal, which has a phase of +90° relative to the first split signal RF1, from the second output port, the power amplifier 11 having the second input port and the third output port, the second input port being coupled to the first output port, the power amplifier 12 having the third input port and the fourth output port, the third input port being coupled to the second output port, the combiner circuit having the fourth input port, the fifth input port, and the fifth output port, configured to combine in antiphase the third split signal input from the fourth input port and the fourth split signal input from the fifth input port to generate an output signal and configured to output the output signal from the fifth output port, the phase shifter circuit 21C coupled between the third output port and the fourth input port, the phase shifter circuit 22C coupled between the fourth output port and the fifth input port, the harmonic phase shifter circuit 31C coupled between the third output port and the fourth input port and/or the harmonic phase shifter circuit 32C coupled between the fourth output port and the fifth input port, and the filter 61 coupled between the fifth output port and the antenna connection terminal 100, having a pass band that includes the transmit band. The phase shifter circuits 21C and 22C are configured such that the forward phase of the fundamental wave of the transmit band in the phase shifter circuit 22C in the direction from the fourth output port to the fifth input port is −90° relative to the forward phase of the fundamental wave in the phase shifter circuit 21C in the direction from the third output port to the fourth input port. The phase shifter circuits 21C and 22C and the harmonic phase shifter circuits 31C and 32C are configured such that: the difference between the first reflection phase of the fundamental wave assuming the fifth output port is observed from the third output port and the second reflection phase of the fundamental wave assuming the fifth output port is observed from the fourth output port is 180°; and the difference between the third reflection phase of the harmonic waves of the transmit band assuming the fifth output port is observed from the third output port and the fourth reflection phase of the harmonic waves of the transmit band assuming the fifth output port is observed from the fourth output port is 180°.

With the configuration described above, assuming unwanted signals at the fundamental and second harmonic frequencies of the band-A transmit band leak into the radio-frequency circuit through the antenna connection terminal 100 from external circuits, the reflection phase difference between the fundamental waves observed from the output ports of the two balanced power amplifiers 11 and 12 is 180°, and the reflection phase difference of the second harmonic waves is also 180°. As a result, fluctuations in the transmission characteristics of the fundamental and harmonic frequency ranges of the radio-frequency circuit can be suppressed regardless of load variations. As such, the amplifier circuit 10C and the radio-frequency circuit are provided in the manner that mitigates fluctuations in transmission characteristics caused by load variations.

In an example, in the radio-frequency circuit according to the third modification, the harmonic wave corresponds to the second harmonic wave having a frequency twice the fundamental wave.

With this configuration, the radio-frequency circuit is provided in the manner that mitigates fluctuations in the output characteristics of the fundamental and second harmonic frequency ranges of transmit signals.

In an example, in the radio-frequency circuit according to the third modification, the harmonic wave corresponds to the third harmonic wave having a frequency three times the fundamental wave.

With this configuration, the radio-frequency circuit is provided in the manner that mitigates fluctuations in the output characteristics of the fundamental and third harmonic frequency ranges of transmit signals.

In an example, in the radio-frequency circuit according to the third modification, the phase shifter circuit 21C is configured such that the forward phase of the fundamental wave is −45°. The phase shifter circuit 22C is configured such that the forward phase of the fundamental wave is +45°. The phase shifter circuit 21C and the harmonic phase shifter circuit 31C are configured such that the forward phase of the harmonic wave in the circuit formed by combining the phase shifter circuit 21C and the harmonic phase shifter circuit 31C is −45°. The phase shifter circuit 22C and the harmonic phase shifter circuit 32C are configured such that the forward phase of the harmonic wave in the circuit formed by combining the phase shifter circuit 22C and the harmonic phase shifter circuit 32C is +45°.

With this configuration, the first signal and the second signal, which are two band-A radio-frequency signals, can be combined in antiphase at the fifth output port. This configuration enables highly efficient power combining of the fundamental wave with respect to load variations. This configuration achieves a 1800 difference between the first reflection phase (−90°) of the fundamental wave of the first signal assuming the fifth output port is observed from the third output port and the second reflection phase (+90°) of the fundamental wave of the second signal assuming the fifth output port is observed from the fourth output port. This configuration achieves a 1800 difference between the third reflection phase of the second harmonic wave of the first signal assuming the fifth output port is observed from the third output port and the fourth reflection phase of the second harmonic wave of the second signal assuming the fifth output port is observed from the fourth output port.

In an example, in the radio-frequency circuit according to the third modification, the phase shifter circuit 21C includes the inductor 221 coupled between the third output port and the fourth input port and the capacitor 223 coupled between ground and the path connecting the inductor 221 and the fourth input port, and the phase shifter circuit 22C includes the capacitor 211 coupled between the fourth output port and the fifth input port and the inductor 213 coupled between ground and the path connecting the capacitor 211 and the fifth input port.

With this configuration, the phase shifter circuit 21C is configured as a low pass filter. This configuration achieves a −45° forward phase of the fundamental wave of the band A. The phase shifter circuit 22C is configured as a high pass filter. This configuration achieves a +45° forward phase of the fundamental wave of the band A.

In an example, in the radio-frequency circuit according to the third modification, the harmonic phase shifter circuit 31C includes an LC circuit including the inductor 321 and the capacitor 322 that are coupled in series with each other. The LC circuit is coupled between ground and the path connecting the third output port and the inductor 221. The harmonic phase shifter circuit 32C includes the capacitor 311 coupled between ground and the path connecting the fourth output port and the capacitor 211.

With this configuration, the harmonic phase shifter circuit 31C operates as a notch filter with a pass band that corresponds to the fundamental frequency range of the band A. This configuration achieves a 0° forward phase of the fundamental wave of the band A. The harmonic phase shifter circuit 32C operates as a low pass filter with a pass band that corresponds to the fundamental frequency range. This configuration achieves a 0° forward phase of the fundamental wave.

### OTHER EMBODIMENTS

The radio-frequency circuit according to an embodiment of the present disclosure have been described by using the embodiment and modification, but the radio-frequency circuit according to the present disclosure are not limited to the embodiment and modification. The present disclosure also embraces other embodiments implemented as any combination of the constituent elements of the embodiment and modification, other modifications obtained by making various modifications to the embodiment that occur to those skilled in the art without departing from the scope of the present disclosure, and various hardware devices including the radio-frequency circuit according to the present disclosure.

For example, in the amplifier circuit, the radio-frequency circuit, and the communication device according to the embodiment and modifications described above, other circuit elements and wire lines may be inserted in the paths connecting the circuit elements and signal paths that are illustrated in the drawings.

The following describes the features of the radio-frequency circuits explained based on the embodiment.
<1> A radio-frequency circuit comprising:
a first antenna terminal;
a splitter having a first input port, a first output port, and a second output port, the splitter being configured to split a fundamental signal of a transmit band of a first band that is input to the first input port, configured to output from the first output port a first split signal, and configured to output from the second output port a second split signal that has a phase of +90° relative to the first split signal;
a first power amplifier having a second input port and a third output port, the second input port being coupled to the first output port;
a second power amplifier having a third input port and a fourth output port, the third input port being coupled to the second output port;
a combiner circuit having a fourth input port, a fifth input port, and a fifth output port, the combiner circuit being configured to combine in phase a third split signal input from the fourth input port and a fourth split signal input from the fifth input port to generate an output signal and configured to output the output signal from the fifth output port;
a first phase shifter circuit coupled between the third output port and the fourth input port;
a second phase shifter circuit coupled between the fourth output port and the fifth input port;
a first harmonic phase shifter circuit coupled between the third output port and the fourth input port and/or a second harmonic phase shifter circuit coupled between the fourth output port and the fifth input port; and
a first filter coupled between the fifth output port and the first antenna terminal, the first filter having a pass band that includes the transmit band, wherein
the first phase shifter circuit and the second phase shifter circuit are configured such that
   a forward phase of a fundamental wave of the transmit band in the second phase shifter circuit in a direction from the fourth output port to the fifth input port is −90° relative to a forward phase of the fundamental wave in the first phase shifter circuit
   in a direction from the third output port to the fourth input port, and
the first phase shifter circuit, the second phase shifter circuit, the first harmonic phase shifter circuit, and the second harmonic phase shifter circuit are configured such that
   a difference between a first reflection phase of the fundamental wave assuming the fifth output port is observed from the third output port and a second reflection phase of the fundamental wave assuming the fifth output port is observed from the fourth output port is 180°, and
   a difference between a third reflection phase of at least one of harmonic waves of the transmit band assuming the fifth output port is observed from the third output port and a fourth reflection phase of the at least one of the harmonic waves assuming the fifth output port is observed from the fourth output port is 180°.
<2> The radio-frequency circuit according to <1>, wherein
the harmonic waves correspond to a second harmonic wave having a frequency twice the fundamental wave.
<3> The radio-frequency circuit according to <1>, wherein
the harmonic waves correspond to a third harmonic wave having a frequency three times the fundamental wave.
<4> The radio-frequency circuit according to any of <1> to <3>, wherein
the first phase shifter circuit is configured such that the forward phase of the fundamental wave is +45°,
the second phase shifter circuit is configured such that the forward phase of the fundamental wave is −45°,
the first phase shifter circuit and the first harmonic phase shifter circuit are configured such that the forward phase of the harmonic waves in a circuit formed by combining the first phase shifter circuit and the first harmonic phase shifter circuit is +45°, and
the second phase shifter circuit and the second harmonic phase shifter circuit are configured such that the forward phase of the harmonic waves in a circuit formed by combining the second phase shifter circuit and the second harmonic phase shifter circuit is −45°.
<5> The radio-frequency circuit according to <4>, wherein
the first phase shifter circuit includes
   a first capacitor coupled between the third output port and the fourth input port, and
   a first inductor coupled between ground and a path connecting the first capacitor and the fourth input port, and
the second phase shifter circuit includes
   a second inductor coupled between the fourth output port and the fifth input port, and
   a second capacitor coupled between ground and a path connecting the second inductor and the fifth input port.
<6> The radio-frequency circuit according to <5>, comprising the first harmonic phase shifter circuit and the second harmonic phase shifter circuit, wherein
the first harmonic phase shifter circuit includes a third capacitor coupled between ground and a path connecting the third output port and the first capacitor, and
the second harmonic phase shifter circuit includes an LC circuit including a third inductor and a fourth capacitor that are coupled in series with each other, and the LC circuit is coupled between ground and a path connecting the fourth output port and the second inductor.
<7> The radio-frequency circuit according to any of <1> to <6>, further comprising:
a second filter having a pass band that includes a transmit band of a second band, wherein
the combiner circuit includes a switching circuit that has the fourth input port, the fifth input port, the fifth output port, and the sixth output port and that is configured to alternate between connecting the fourth input port and the fifth output port while connecting the fifth input port and the fifth output port and connecting the fourth input port and the sixth output port while connecting the fifth input port and the sixth output port, and
the second filter is coupled to the sixth output port.
<8> The radio-frequency circuit according to <7>, wherein
the switching circuit is included in a semiconductor integrated circuit (IC),
the switching circuit includes
   a first switch coupled to the fourth input port and the fifth output port,
   a second switch coupled to the fourth input port and the sixth output port,
   a third switch coupled to the fifth input port and the fifth output port, and
   a fourth switch coupled to the fifth input port and the sixth output port, and
assuming a major surface of the semiconductor IC is viewed in plan view,
   the first switch and the third switch are positioned between the fourth input port and the fifth input port,
   the fifth output port is positioned between the first switch and the third switch,
   the second switch and the fourth switch are positioned between the fourth input port and the fifth input port, and
   the sixth output port is positioned between the second switch and the fourth switch.
<9> The radio-frequency circuit according to <7> or <8>, wherein
the switching circuit further includes a monitoring terminal, and
the monitoring terminal is configured to be connected to the fourth input port in a state in which the fourth input port is disconnected from the fifth output port and the sixth output port or to be connected to the fifth input port in a state in which the fifth input port is disconnected from the fifth output port and the sixth output port.
<10> The radio-frequency circuit according to any of <7> to <9>, wherein
at least one of the first phase shifter circuit and the second phase shifter circuit is configured such that a forward phase is changed by alternating between connecting the fourth input port and the fifth input port to the fifth output port and connecting the fourth input port and the fifth input port to the sixth output port.
<11> The radio-frequency circuit according to <10>, wherein
the switching circuit is included in a semiconductor IC,
the first phase shifter circuit includes a first variable circuit having a fifth switch and at least one of an inductor and a capacitor that is coupled to the fifth switch,
the second phase shifter circuit includes a second variable circuit having a sixth switch and at least one of an inductor and a capacitor that is coupled to the sixth switch,
the first variable circuit is coupled to the fourth input port and included in the semiconductor IC, and
the second variable circuit is coupled to the fifth input port and included in the semiconductor IC.
<12> The radio-frequency circuit according to any of <7> to <11>, comprising the first harmonic phase shifter circuit and the second harmonic phase shifter circuit, wherein
at least one of the first harmonic phase shifter circuit and the second harmonic phase shifter circuit is configured such that a forward phase is changed by alternating between connecting the fourth input port and the fifth input port to the fifth output port and connecting the fourth input port and the fifth input port to the sixth output port.
<13> The radio-frequency circuit according to <12>, wherein
the switching circuit is included in a semiconductor IC,
the first harmonic phase shifter circuit includes a third variable circuit having a seventh switch and at least one of an inductor and a capacitor that is coupled to the seventh switch,
the second harmonic phase shifter circuit includes a fourth variable circuit having an eighth switch and at least one of an inductor and a capacitor that is coupled to the eighth switch, and
the third variable circuit and the fourth variable circuit are included in the semiconductor IC.
<14> The radio-frequency circuit according to any of <1> to <13>, further comprising:
a second antenna terminal;
a third power amplifier; and
a third filter coupled between the second antenna terminal and an output port of the third power amplifier, the third filter having a pass band that includes the transmit band of the first band.
<15> A radio-frequency circuit comprising:
a first antenna terminal;
a splitter having a first input port, a first output port, and a second output port, the splitter being configured to split a fundamental signal of a transmit band of a first band that is input to the first input port, configured to output from the first output port a first split signal, and configured to output from the second output port a second split signal that has a phase of +90° relative to the first split signal;
a first power amplifier having a second input port and a third output port, the second input port being coupled to the first output port;
a second power amplifier having a third input port and a fourth output port, the third input port being coupled to the second output port;
a combiner circuit having a fourth input port, a fifth input port, and a fifth output port, the combiner circuit being configured to combine in antiphase a third split signal input from the fourth input port and a fourth split signal input from the fifth input port to generate an output signal and configured to output the output signal from the fifth output port;
a first phase shifter circuit coupled between the third output port and the fourth input port;
a second phase shifter circuit coupled between the fourth output port and the fifth input port;
a first harmonic phase shifter circuit coupled between the third output port and the fourth input port and/or a second harmonic phase shifter circuit coupled between the fourth output port and the fifth input port; and
a first transmit filter coupled between the fifth output port and the first antenna terminal, the first transmit filter having a pass band that includes the transmit band, wherein
the first phase shifter circuit and the second phase shifter circuit are configured such that
   a forward phase of a fundamental wave of the transmit band in the second phase shifter circuit in a direction from the fourth output port to the fifth input port is −90° relative to a forward phase of the fundamental wave in the first phase shifter circuit in a direction from the third output port to the fourth input port, and
the first phase shifter circuit, the second phase shifter circuit, the first harmonic phase shifter circuit, and the second harmonic phase shifter circuit are configured such that
   a difference between a first reflection phase of the fundamental wave assuming the fifth output port is observed from the third output port and a second reflection phase of the fundamental wave assuming the fifth output port is observed from the fourth output port is 180°, and
   a difference between a third reflection phase of at least one of harmonic waves of the transmit band assuming the fifth output port is observed from the third output port and a fourth reflection phase of the at least one of the harmonic waves assuming the fifth output port is observed from the fourth output port is 180°.
<16> The radio-frequency circuit according to <15>, wherein
the harmonic waves correspond to a second harmonic wave having a frequency twice the fundamental wave.
<17> The radio-frequency circuit according to <15>, wherein
the harmonic waves correspond to a third harmonic wave having a frequency three times the fundamental wave.
<18> The radio-frequency circuit according to any of <15> to <17>, wherein
the first phase shifter circuit is configured such that the forward phase of the fundamental wave is −45°,
the second phase shifter circuit is configured such that the forward phase of the fundamental wave is +45°,
the first phase shifter circuit and the first harmonic phase shifter circuit are configured such that the forward phase of the harmonic waves in a circuit formed by combining the first phase shifter circuit and the first harmonic phase shifter circuit is −45°, and
the second phase shifter circuit and the second harmonic phase shifter circuit are configured such that the forward phase of the harmonic waves in a circuit formed by combining the second phase shifter circuit and the second harmonic phase shifter circuit is +45°.
<19> The radio-frequency circuit according to <18>, wherein
the first phase shifter circuit includes
   a first inductor coupled between the third output port and the fourth input port, and
   a first capacitor coupled between ground and a path connecting the first inductor and the fourth input port, and
the second phase shifter circuit includes
   a second capacitor coupled between the fourth output port and the fifth input port, and
   a second inductor coupled between ground and a path connecting the second capacitor and the fifth input port.
<20> The radio-frequency circuit according to <19>, comprising the first harmonic phase shifter circuit and the second harmonic phase shifter circuit, wherein
the first harmonic phase shifter circuit includes an LC circuit including a third inductor and a third capacitor that are coupled in series with each other, and the LC circuit is coupled between ground and a path connecting the third output port and the first inductor, and
the second harmonic phase shifter circuit includes a fourth capacitor coupled between ground and a path connecting the fourth output port and the second capacitor.

The present disclosure can be used as an amplifier circuit, a radio-frequency circuit, or a communication device provided at the front-end, in a wide variety of communication hardware, such as mobile phones.

What is claimed is:

1. A radio-frequency circuit comprising:
a first antenna terminal;
a splitter having a first input port, a first output port, and a second output port, the splitter being configured to split a fundamental signal of a transmit band of a first band that is input to the first input port, configured to output from the first output port a first split signal, and configured to output from the second output port a second split signal that has a phase of +90° relative to the first split signal;
a first power amplifier having a second input port and a third output port, the second input port being coupled to the first output port;
a second power amplifier having a third input port and a fourth output port, the third input port being coupled to the second output port;
a combiner circuit having a fourth input port, a fifth input port, and a fifth output port, the combiner circuit being configured to combine in phase a third split signal input from the fourth input port and a fourth split signal input from the fifth input port to generate an output signal and configured to output the output signal from the fifth output port;
a first phase shifter circuit coupled between the third output port and the fourth input port;
a second phase shifter circuit coupled between the fourth output port and the fifth input port;
a first harmonic phase shifter circuit coupled between the third output port and the fourth input port and/or a second harmonic phase shifter circuit coupled between the fourth output port and the fifth input port; and
a first filter coupled between the fifth output port and the first antenna terminal, the first filter having a pass band that includes the transmit band, wherein
the first phase shifter circuit and the second phase shifter circuit are configured such that
a forward phase of a fundamental wave of the transmit band in the second phase shifter circuit in a direction from the fourth output port to the fifth input port is −90° relative to a forward phase of the fundamental wave in the first phase shifter circuit in a direction from the third output port to the fourth input port, and
the first phase shifter circuit, the second phase shifter circuit, the first harmonic phase shifter circuit, and the second harmonic phase shifter circuit are configured such that
a difference between a first reflection phase of the fundamental wave assuming the fifth output port is observed from the third output port and a second reflection phase of the fundamental wave assuming the fifth output port is observed from the fourth output port is 180°, and
a difference between a third reflection phase of at least one of harmonic waves of the transmit band assuming the fifth output port is observed from the third output port and a fourth reflection phase of the at least one of the harmonic waves assuming the fifth output port is observed from the fourth output port is 180°.

2. The radio-frequency circuit according to claim 1, wherein
the harmonic waves correspond to a second harmonic wave having a frequency twice the fundamental wave.

3. The radio-frequency circuit according to claim 1, wherein
the harmonic waves correspond to a third harmonic wave having a frequency three times the fundamental wave.

4. The radio-frequency circuit according to claim 1, wherein
the first phase shifter circuit is configured such that the forward phase of the fundamental wave is +45°,
the second phase shifter circuit is configured such that the forward phase of the fundamental wave is −45°,
the first phase shifter circuit and the first harmonic phase shifter circuit are configured such that the forward phase of the harmonic waves in a circuit formed by combining the first phase shifter circuit and the first harmonic phase shifter circuit is +45°, and
the second phase shifter circuit and the second harmonic phase shifter circuit are configured such that the forward phase of the harmonic waves in a circuit formed by combining the second phase shifter circuit and the second harmonic phase shifter circuit is −45°.

5. The radio-frequency circuit according to claim 4, wherein
the first phase shifter circuit includes
a first capacitor coupled between the third output port and the fourth input port, and
a first inductor coupled between ground and a path connecting the first capacitor and the fourth input port, and
the second phase shifter circuit includes
a second inductor coupled between the fourth output port and the fifth input port, and
a second capacitor coupled between ground and a path connecting the second inductor and the fifth input port.

6. The radio-frequency circuit according to claim 5, comprising the first harmonic phase shifter circuit and the second harmonic phase shifter circuit, wherein
the first harmonic phase shifter circuit includes a third capacitor coupled between ground and a path connecting the third output port and the first capacitor, and
the second harmonic phase shifter circuit includes an LC circuit including a third inductor and a fourth capacitor that are coupled in series with each other, and the LC circuit is coupled between ground and a path connecting the fourth output port and the second inductor.

7. The radio-frequency circuit according to claim 6, further comprising:
a second filter having a pass band that includes a transmit band of a second band, wherein
the combiner circuit includes a switching circuit that has the fourth input port, the fifth input port, the fifth output port, and the sixth output port and that is configured to alternate between connecting the fourth input port and the fifth output port while connecting the fifth input port and the fifth output port and connecting the fourth input port and the sixth output port while connecting the fifth input port and the sixth output port, and
the second filter is coupled to the sixth output port.

8. The radio-frequency circuit according to claim 7, wherein
the switching circuit is included in a semiconductor integrated circuit (IC),
the switching circuit includes
a first switch coupled to the fourth input port and the fifth output port,
a second switch coupled to the fourth input port and the sixth output port,
a third switch coupled to the fifth input port and the fifth output port, and
a fourth switch coupled to the fifth input port and the sixth output port, and
assuming a major surface of the semiconductor IC is viewed in plan view,
the first switch and the third switch are positioned between the fourth input port and the fifth input port,
the fifth output port is positioned between the first switch and the third switch,
the second switch and the fourth switch are positioned between the fourth input port and the fifth input port, and
the sixth output port is positioned between the second switch and the fourth switch.

9. The radio-frequency circuit according to claim 7,
wherein the switching circuit further includes a monitoring terminal, and
the monitoring terminal is configured to be connected to the fourth input port in a state in which the fourth input port is disconnected from the fifth output port and the sixth output port or to be connected to the fifth input port in a state in which the fifth input port is disconnected from the fifth output port and the sixth output port.

10. The radio-frequency circuit according to claim 7, wherein
at least one of the first phase shifter circuit and the second phase shifter circuit is configured such that a forward phase is changed by alternating between connecting the fourth input port and the fifth input port to the fifth output port and connecting the fourth input port and the fifth input port to the sixth output port.

11. The radio-frequency circuit according to claim 10, wherein
the switching circuit is included in a semiconductor IC,
the first phase shifter circuit includes a first variable circuit having a fifth switch and at least one of an inductor and a capacitor that is coupled to the fifth switch,
the second phase shifter circuit includes a second variable circuit having a sixth switch and at least one of an inductor and a capacitor that is coupled to the sixth switch,
the first variable circuit is coupled to the fourth input port and included in the semiconductor IC, and
the second variable circuit is coupled to the fifth input port and included in the semiconductor IC.

12. The radio-frequency circuit according to claim 7, comprising the first harmonic phase shifter circuit and the second harmonic phase shifter circuit, wherein
at least one of the first harmonic phase shifter circuit and the second harmonic phase shifter circuit is configured such that a forward phase is changed by alternating between connecting the fourth input port and the fifth input port to the fifth output port and connecting the fourth input port and the fifth input port to the sixth output port.

13. The radio-frequency circuit according to claim 12, wherein
the switching circuit is included in a semiconductor IC,
the first harmonic phase shifter circuit includes a third variable circuit having a seventh switch and at least one of an inductor and a capacitor that is coupled to the seventh switch,
the second harmonic phase shifter circuit includes a fourth variable circuit having an eighth switch and at least one of an inductor and a capacitor that is coupled to the eighth switch, and
the third variable circuit and the fourth variable circuit are included in the semiconductor IC.

14. The radio-frequency circuit according claim 6, further comprising:
a second antenna terminal;
a third power amplifier; and
a third filter coupled between the second antenna terminal and an output port of the third power amplifier, the third filter having a pass band that includes the transmit band of the first band.

15. A radio-frequency circuit comprising:
a first antenna terminal;
a splitter having a first input port, a first output port, and a second output port, the splitter being configured to split a fundamental signal of a transmit band of a first band that is input to the first input port, configured to output from the first output port a first split signal, and configured to output from the second output port a second split signal that has a phase of +90° relative to the first split signal;
a first power amplifier having a second input port and a third output port, the second input port being coupled to the first output port;
a second power amplifier having a third input port and a fourth output port, the third input port being coupled to the second output port;
a combiner circuit having a fourth input port, a fifth input port, and a fifth output port, the combiner circuit being configured to combine in antiphase a third split signal input from the fourth input port and a fourth split signal input from the fifth input port to generate an output signal and configured to output the output signal from the fifth output port;
a first phase shifter circuit coupled between the third output port and the fourth input port;
a second phase shifter circuit coupled between the fourth output port and the fifth input port;
a first harmonic phase shifter circuit coupled between the third output port and the fourth input port and/or a second harmonic phase shifter circuit coupled between the fourth output port and the fifth input port; and
a first transmit filter coupled between the fifth output port and the first antenna terminal, the first transmit filter having a pass band that includes the transmit band, wherein
the first phase shifter circuit and the second phase shifter circuit are configured such that
a forward phase of a fundamental wave of the transmit band in the second phase shifter circuit in a direction from the fourth output port to the fifth input port is −90° relative to a forward phase of the fundamental wave in the first phase shifter circuit in a direction from the third output port to the fourth input port, and
the first phase shifter circuit, the second phase shifter circuit, the first harmonic phase shifter circuit, and the second harmonic phase shifter circuit are configured such that
a difference between a first reflection phase of the fundamental wave assuming the fifth output port is observed from the third output port and a second reflection phase of the fundamental wave assuming the fifth output port is observed from the fourth output port is 180°, and
a difference between a third reflection phase of at least one of harmonic waves of the transmit band assuming the fifth output port is observed from the third output port and a fourth reflection phase of the at least one of the harmonic waves assuming the fifth output port is observed from the fourth output port is 180°.

16. The radio-frequency circuit according to claim 15, wherein
the harmonic waves correspond to a second harmonic wave having a frequency twice the fundamental wave.

17. The radio-frequency circuit according to claim 15, wherein
the harmonic waves correspond to a third harmonic wave having a frequency three times the fundamental wave.

18. The radio-frequency circuit according to claim 17, wherein
the first phase shifter circuit is configured such that the forward phase of the fundamental wave is −45°,
the second phase shifter circuit is configured such that the forward phase of the fundamental wave is +45°,
the first phase shifter circuit and the first harmonic phase shifter circuit are configured such that the forward phase of the harmonic waves in a circuit formed by combining the first phase shifter circuit and the first harmonic phase shifter circuit is −45°, and
the second phase shifter circuit and the second harmonic phase shifter circuit are configured such that the forward phase of the harmonic waves in a circuit formed by combining the second phase shifter circuit and the second harmonic phase shifter circuit is +45°.

19. The radio-frequency circuit according to claim 18, wherein
the first phase shifter circuit includes
a first inductor coupled between the third output port and the fourth input port, and
a first capacitor coupled between ground and a path connecting the first inductor and the fourth input port, and
the second phase shifter circuit includes
a second capacitor coupled between the fourth output port and the fifth input port, and
a second inductor coupled between ground and a path connecting the second capacitor and the fifth input port.

20. The radio-frequency circuit according to claim 19, comprising the first harmonic phase shifter circuit and the second harmonic phase shifter circuit, wherein
the first harmonic phase shifter circuit includes an LC circuit including a third inductor and a third capacitor that are coupled in series with each other, and the LC circuit is coupled between ground and a path connecting the third output port and the first inductor, and
the second harmonic phase shifter circuit includes a fourth capacitor coupled between ground and a path connecting the fourth output port and the second capacitor.
